(19) United States
(12) Patent Application Publication
(10) Pub. No.: US 2025/0282056 A1
(43) Pub. Date: Sep. 11, 2025

(54) ROBOT SYSTEM, CONTROL METHOD FOR ROBOT SYSTEM, MANUFACTURING METHOD FOR ARTICLE USING ROBOT SYSTEM, INFORMATION PROCESSING APPARATUS, INFORMATION PROCESSING METHOD, PROGRAM, AND RECORDING MEDIUM

(71) Applicant: CANON KABUSHIKI KAISHA, Tokyo (JP)

(72) Inventor: YUSAKU MOTONAGA, Tokyo (JP)

(21) Appl. No.: 19/217,439

(22) Filed: May 23, 2025

Related U.S. Application Data
(63) Continuation of application No. PCT/JP2023/041486, filed on Nov. 17, 2023.

(30) Foreign Application Priority Data
Nov. 29, 2022 (JP) 2022-190044

(51) Int. Cl. B25J 11/00; B25J 9/16

(52) U.S. Cl. CPC B25J 11/0005; B25J 9/1689

(57) ABSTRACT

A robot system includes a robot and a controller that controls the robot. The controller, when a user is moving a predetermined part of the robot or moving the predetermined part with a terminal device, notifies the user that the predetermined part is moving from a first position to a second position.

### CROSS-REFERENCE TO RELATED APPLICATIONS

This application is a Continuation of International Patent Application No. PCT/JP2023/041486, filed Nov. 17, 2023, which claims the benefit of Japanese Patent Application No. 2022-190044, filed Nov. 29, 2022, both of which are hereby incorporated by reference herein in their entirety.

### BACKGROUND

### Field of the Technology

The present disclosure relates to a robot.

### Description of the Related Art

In recent years, collaborative robots capable of performing collaborative work with operators have been developed in the field of industrial robots. This collaborative robot allows an operator to perform direct teaching, in which the operator teaches the robot by directly touching the robot to change the posture of the robot. With this direct teaching, a user is able to intuitively operate the robot, so it is possible to easily perform teaching. PTL 1 describes a method for a robot to move in plot units during direct teaching by providing discrete, virtual three-dimensional plots in the working space of the robot for the purpose of improving the operability of robot operation by the user.

### CITATION LIST

### Patent Literature

PTL 1 PCT Japanese Translation Patent Publication No. 2018-532608

However, PTL 1 does not discuss how to notify the user of the amount of movement of the robot when the user operates the robot. By notifying the user of the amount of movement of the robot, it is possible to further improve the operability of robot operation by the user.

### SUMMARY

The present disclosure aims to improve the operability of robot operation by a user.

In the present disclosure, a robot system includes a robot and a controller that controls the robot, wherein the controller, when a user is moving a predetermined part of the robot, notifies the user that the predetermined part is moving from a first position to a second position.

Features of the present disclosure will become apparent from the following description of exemplary embodiments with reference to the attached drawings.

### BRIEF DESCRIPTION OF THE DRAWINGS

FIG. 1 is a schematic diagram of a robot system 1000 in an embodiment.

FIG. 2 is a control block diagram of the robot system 1000 in the embodiment.

FIG. 3A is a diagram showing a virtual coordinate system and a virtual reference coordinate 3001 of a working space of the robot system 1000 in the embodiment.

FIG. 3B is a diagram for illustrating virtual repulsion in the embodiment.

FIG. 3C is a diagram for illustrating virtual attraction in the embodiment.

FIG. 4A is a diagram for illustrating a method of notifying a user by a change in operating force in the embodiment.

FIG. 4B is a diagram for illustrating a method of notifying a user by a change in operating force in the embodiment.

FIG. 5 is a control flowchart in the embodiment.

FIG. 6A is a diagram for illustrating a method of notifying a user by a change in operating force in an embodiment.

FIG. 6B is a diagram for illustrating a method of notifying a user by a change in operating force in the embodiment.

FIG. 6C is a diagram for illustrating a method of notifying a user by a change in operating force in the embodiment.

FIG. 7 is a control flowchart in the embodiment.

FIG. 8 is a diagram for illustrating a method of notifying a user by a change in operating force in the embodiment.

FIG. 9 is a diagram for illustrating a method of notifying a user by a change in operating force in an embodiment.

FIG. 10 is a diagram for illustrating a method of notifying a user by a change in operating force in an embodiment.

FIG. 11 is a control flowchart in the embodiment.

FIG. 12 is a diagram for illustrating a method of notifying a user by a change in operating force in an embodiment.

FIG. 13 is a diagram for illustrating a method of notifying a user by a change in operating force in the embodiment.

FIG. 14 is a control flowchart in the embodiment.

FIG. 15 is a diagram for illustrating a method of notifying a user by light in an embodiment.

FIG. 16 is a control flowchart in the embodiment.

FIG. 17 is a diagram for illustrating a method of notifying a user by light in the embodiment.

FIG. 18 is a control flowchart in the embodiment.

FIG. 19 is a diagram for illustrating a method of notifying a user by sound in an embodiment.

FIG. 20 is a control flowchart in the embodiment.

FIG. 21 is a diagram for illustrating a method of notifying a user by sound in the embodiment.

FIG. 22 is a control flowchart in the embodiment.

FIG. 23 is a diagram for illustrating a method of notifying a user by sound in the embodiment.

FIG. 24 is a diagram for illustrating a method of notifying a user by sound in an embodiment.

FIG. 25 is a control flowchart in the embodiment.

FIG. 26 is an example of a direct teaching settings screen 800 in an embodiment.

FIG. 27 is a diagram for illustrating a method of notifying a user by vibration in an embodiment.

FIG. 28 is a diagram for illustrating a method of notifying a user by an external input device 500 in an embodiment.

### DESCRIPTION OF THE EMBODIMENTS

Hereinafter, embodiments of the present disclosure will be described with reference to the attached drawings. The embodiments described below are only illustrative, and, for example, the configuration of detailed parts may be modified as needed by persons skilled in the art without departing from the purport of the present disclosure. Numeric values described in the present embodiments are reference numeric values and do not limit the present disclosure. In the following drawings, the arrows X, Y, Z in the drawings represent the overall coordinate system of a robot system. Generally, an XYZ three-dimensional coordinate system represents a world coordinate system of an overall installation environment. Other than that, for the sake of convenience of control, a local coordinate system may be used as needed for a robot hand, a finger part, a joint, or the like.

### First Embodiment

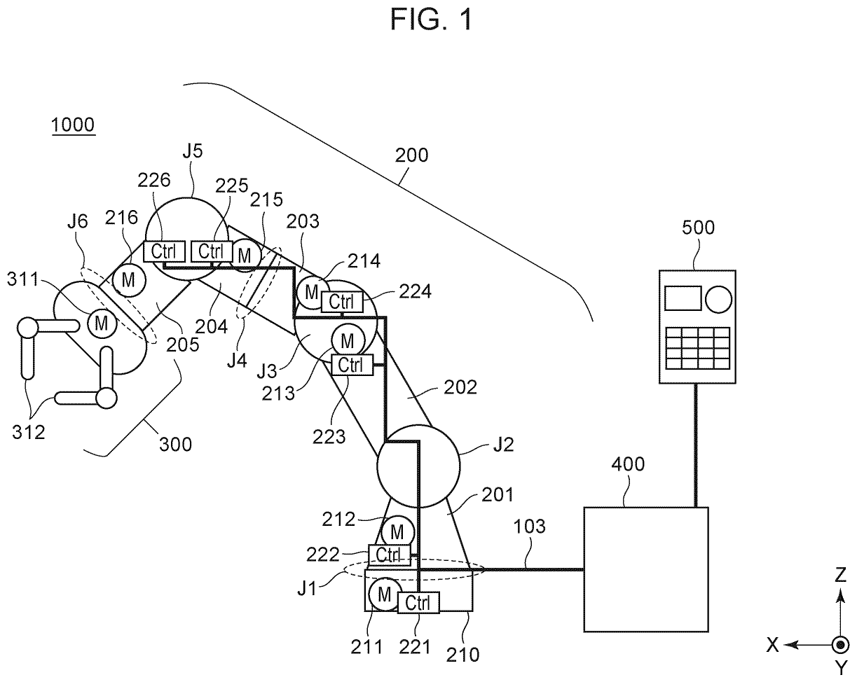

FIG. 1 is a schematic diagram of the robot system 1000 in the present embodiment when viewed in a selected direction in an XYZ coordinate system. As shown in FIG. 1, the robot system 1000 includes an articulated robot arm body 200 and a robot hand body 300 as a robot body. The robot system 1000 further includes a controller 400 that controls the operation of the entire robot body. The robot system 1000 also includes an external input device 500 as a teaching device that transmits teaching data to the controller 400. One example of the external input device 500 includes a teaching pendant. The external input device 500 is used by an operator to designate the position of the robot arm body 200 and the position of the robot hand body 300.

In the present embodiment, the description will be made when a robot hand is provided at the distal end part of the robot arm body 200 as an end effector; however, a device provided at the distal end part of the robot arm body 200 is not limited thereto, and the device may be a tool or the like.

A link 201 that is the proximal end of the robot arm body 200 is provided at a base 210. The robot arm body 200 includes a base 210, a plurality of joints J1 to J6, for example, six joints (six axes), and a plurality of links 201 to 205. The robot arm body 200 further includes a plurality of (six) arm motors 211 to 216 at the joints J1 to J6 as drive sources that respectively rotationally drive the joints around their rotation axes. Each of the arm motors 211 to 216 includes a motor encoder (not shown) that detects the rotational position of a motor output shaft.

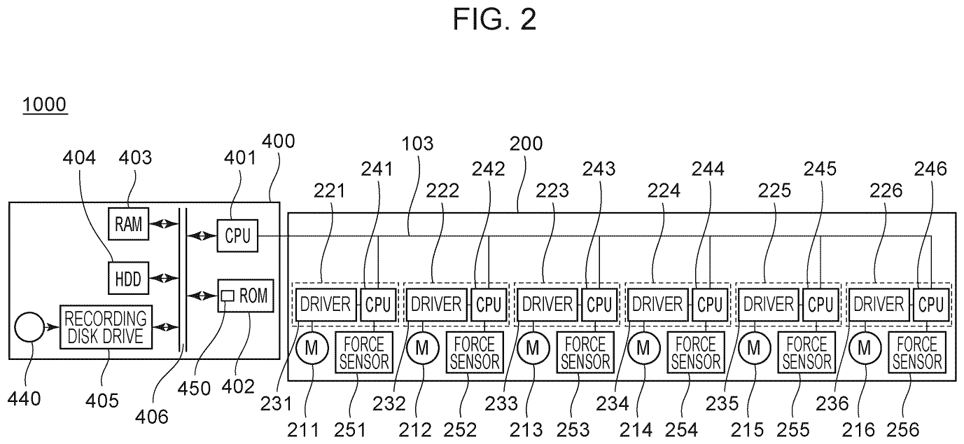

The robot arm body 200 further includes arm motor controllers 221 to 226 for respectively controlling the arm motors 211 to 216, and includes force sensors 251 to 256 (FIG. 2) each of which detects torque as information about a force acting on a corresponding one of the joints. For the sake of simplicity, in FIG. 1, the arm motor controllers 221 to 226 are shown outside the robot arm body 200; however, it is assumed that the arm motor controllers 221 to 226 are respectively provided near the corresponding arm motors 211 to 216 inside the base 210 and the links 201 to 205.

In the robot arm body 200, the plurality of links 201 to 205 and the robot hand body 300 are rotatably connected at the joints J1 to J6. Here, the links 201 to 205 are sequentially connected in series from the proximal end to the distal end of the robot arm body 200.

As shown in the diagram, the base 210 and link 201 of the robot arm body 200 are connected by the joint J1 that rotates in the direction of the arrow around the X-axis in the diagram. The link 201 can receive the rotation of the arm motor 211, transmitted through a transmission mechanism (not shown), and rotate in the direction of the arrow around the Z-axis in the diagram.

The link 201 and link 202 of the robot arm body 200 are connected by the joint J2 that rotates in the direction of the arrow around the Y-axis in the diagram. The link 202 can receive the rotation of the arm motor 212, transmitted through a transmission mechanism (not shown), and rotate in the direction of the arrow around the Y-axis in the diagram.

The link 202 and link 203 of the robot arm body 200 are connected by the joint J3 that rotates in the direction of the arrow around the Y-axis in the diagram. The link 203 can receive the rotation of the arm motor 213, transmitted through a transmission mechanism (not shown), and rotate in the direction of the arrow around the Y-axis in the diagram.

The link 203 and link 204 of the robot arm body 200 are connected by the joint J4 that rotates in the direction of the arrow around a predetermined axis positioned in the XZ plane in the diagram. The link 204 can receive the rotation of the arm motor 214, transmitted through a transmission mechanism (not shown), and rotate in the direction of the arrow around the predetermined axis positioned in the XZ plane in the diagram.

The link 204 and link 205 of the robot arm body 200 are connected by the joint J5 that rotates in the direction of the arrow around the Y-axis in the diagram. The link 205 can receive the rotation of the arm motor 215, transmitted through a transmission mechanism (not shown), and rotate in the direction of the arrow around the Y-axis in the diagram.

The link 205 of the robot arm body 200 and the robot hand body 300 are connected by the joint J6 that rotates in the direction of the arrow around a predetermined axis positioned in the XZ plane in the diagram. The robot hand body 300 can receive the rotation of the arm motor 216, transmitted through a transmission mechanism (not shown), and rotate in the direction of the arrow around the predetermined axis positioned in the XZ plane in the diagram.

The robot hand body 300 is used to grip an object, such as a component and a tool. The robot hand body 300 of the present embodiment opens and closes two finger parts 312 with a drive mechanism (not shown) and a hand motor 311 to grip or release a workpiece, and grips a workpiece so as not to displace the workpiece relative to the robot arm body 200.

The robot hand body 300 includes a built-in hand motor controller (not shown) for controlling the drive of the hand motor 311. The robot hand body 300 is connected to the link 205 via the joint J6. When the joint J6 rotates, the robot hand body 300 can also be rotated.

Each of the arm motor controllers 221 to 226 is communicably connected to the controller 400 by a communication line 103. The communication line 103 is a communication line that connects the controller 400 to each of the arm motor controllers 221 to 226 and that is used for communicating instructions from the controller 400 and replies from the arm motor controllers 221 to 226.

The controller 400 transmits controlled target values for the arm motors 211 to 216 to the arm motor controllers 221 to 226 based on motion trajectories and the like input in advance from the external input device 500, to integrate and control the arm motor controllers 221 to 226. Each of the arm motor controllers 221 to 226 transmits various information such as the current angle of a corresponding one of the arm motors 211 to 216 to the controller 400. The transmission from the controller 400 to each of the arm motor controllers 221 to 226 and the transmission from each of the arm motor controllers 221 to 226 to the controller 400 are performed at a predetermined communication cycle. The connection method between the controller 400 and each of the arm motor controllers 221 to 226 may be a cascade connection, a bus connection, or a daisy chain connection. In the present embodiment, a bus connection is used for description.

Here, the hand part of the robot arm body 200 is the robot hand body 300 in the present embodiment. When the robot hand body 300 is gripping an object, the hand part of the robot arm body 200 includes the robot hand body 300 and the object being gripped (such as a component and a tool). In other words, regardless of whether the robot hand body 300 is in a state of gripping an object or in a state of gripping no object, the robot hand body 300 that is an end effector is referred to as a hand part.

With the above configuration, the robot hand body 300 can be moved by the robot arm body 200 to a selected position and be caused to perform a desired task. For example, it is possible to manufacture an assembled workpiece as a product by using a predetermined workpiece and a different workpiece as materials and performing a process of assembling the predetermined workpiece and the different workpiece. As a result, it is possible to manufacture an article with the robot arm body 200.

The robot hand body 300 may be an end effector or the like, such as a pneumatically-driven air hand. The robot hand body 300 is assumed to be attached to the link 205 by a semi-fixed means, such as screw fastening, or can be attached by an attaching/detaching means, such as latch fastening. Particularly, when the robot hand body 300 is detachably attachable, a system in which the robot arm body 200 is controlled to detach and attach or replace multiple types of robot hand bodies 300 placed at a supply position through the action of the robot arm body 200 itself is also conceivable.

FIG. 2 is a control block diagram of the robot arm body 200. The arm motor controllers 221 to 226 respectively provided at the joints of the robot arm body 200 respectively include motor drivers 231 to 236 and CPUs (central processing units) 241 to 246, and are respectively connected to corresponding force sensors 251 to 256.

The controller 400 includes a CPU 401, and an ROM (read only memory) 402, an RAM (random access memory) 403, an HDD (hard disk drive) 404, and a recording disk drive 405 as a storage portion. The controller 400 includes an input/output interface (not shown) for communicating with the external input device 500. The CPU 401, the ROM 402, the RAM 403, the HDD 404, and the recording disk drive 405 are communicably connected by a bus 406. Furthermore, the communication line 103 is connected to the CPU 401 so that the CPU 401 can communicate with each of the CPUs 241 to 246 of the joints.

The ROM 402 is a non-transitory storage device. The ROM 402 stores a basic program 450, such as BIOS, that is used to cause the CPU 401 to execute various arithmetic processing and that is read by the CPU 401 during start-up time. The CPU 401 executes various arithmetic processing in accordance with the basic program recorded on (stored on) the ROM 402. The basic program 450 can be stored on the HDD 404.

The RAM 403 is a temporary storage device used in arithmetic processing of the CPU 401. The HDD 404 is a non-transitory storage device that stores various data, such as arithmetic processing results of the CPU 401. The recording disk drive 405 is capable of reading various data, programs, and the like, recorded on a recording disk 440.

In the present embodiment, the basic program 450 is recorded on the ROM 402; however, the configuration is not limited thereto. The basic program 450 may be recorded on any recording medium as long as the recording medium is a non-transitory computer-readable recording medium. Examples of the recording medium for supplying the basic program 450 to a computer include a flexible disk, an optical disk, a magneto-optical disc, a magnetic tape, and a nonvolatile memory.

Each of the CPUs 241 to 246 is a CPU that controls a corresponding one of the arm motors 211 to 216 in accordance with an instruction from the CPU 401 of the controller 400. Each of the force sensors 251 to 256 is a sensor that periodically detects the force applied to a corresponding one of the joints J1 to J6 and that outputs the detection result to a corresponding one of the control CPUs 241 to 246. In the present embodiment, a torque sensor is used to detect the torque applied to each joint as a force, but the sensor is not limited thereto. If the sensor is capable of acquiring information about a disturbance on the robot arm body 200, any type of sensor may be used. Each of the motor drivers 231 to 236 is a driver circuit that generates current to control a corresponding one of the arm motors 211 to 216 based on the input signal of a corresponding one of the control CPUs 241 to 246.

The CPU 401 receives teaching point data input from, for example, the external input device 500 via an interface (not shown). The CPU 401 is also capable of generating the trajectory of each axis of the robot arm body 200 based on the teaching point data input from the external input device 500 and transmitting the trajectory to a corresponding one of the CPUs 241 to 245 via the communication line 103. The CPU 401 outputs data of a drive instruction indicating the controlled amount of the rotation angle of each of the arm motors 211 to 216 to a corresponding one of the CPUs 241 to 246 at predetermined intervals.

Each of the CPUs 241 to 246 calculates the amount of current output to a corresponding one of the arm motors 211 to 216 based on the drive instruction received from the CPU 401 and outputs the calculated amount of current to a corresponding one of the motor drivers 231 to 236. Each of the motor drivers 231 to 236 supplies current to a corresponding one of the arm motors 211 to 216 to control the joint angle of a corresponding one of the joints J1 to J6. Each of the CPUs 241 to 246 executes feedback control of a corresponding one of the arm motors 211 to 216 such that the current joint angle value of a corresponding one of the joints J1 to J6, acquired based on the rotation angle of the motor output shaft, detected by a motor encoder (not shown), becomes a target joint angle.

Each of the force sensors 251 to 256 outputs information related to a force, which is a detection result, to a corresponding one of the CPUs 241 to 246. In other words, each of the CPUs 241 to 246 is capable of acquiring a change in torque applied to a corresponding one of the joints J1 to J6 and detected by a corresponding one of the force sensors 251 to 256. It is also possible to perform force control and stop the robot arm body 200 based on the information about the force from the force sensors 251 to 256. Based on the detection results from these force sensors 251 to 256, it is possible to perform direct teaching to control and teach the robot based on the forces generated by the user directly operating the robot arm body 200.

Here, the basic control of direct teaching according to the present embodiment will be briefly described. In the present embodiment, impedance control, which is a type of force control, will be described as an example of a method of executing direct teaching. Impedance control means control in a manner such that there are a virtual spring and a virtual damper between the hand part position (current position) and target position of the robot arm body 200 and the hand part of the robot arm body 200 is operated as if the force based on the size of the spring and damper is generated at the hand part of the robot arm body 200.

Where D denotes a damping coefficient, K denotes a spring coefficient, x denotes a current position, and xd denotes a target position (fulcrum of the spring), a target force (the force to be generated at the hand part of the robot) Fd is expressed as follows.

$$D ( x ( \cdot ) - x ( \cdot ) d ) + K ( x - xd ) = Fd$$

In direct teaching, the target position xd is set based on, for example, the magnitude of force applied by human operation, and the target force Fd is determined according to the damping coefficient D and the spring coefficient K. In short, in the present embodiment, the damping coefficient D and the spring coefficient K in impedance control are used as force control parameters in the present embodiment. However, using the damping coefficient D and the spring coefficient K as force control parameters as in the case of the first embodiment is just one example and does not limit the force control parameters to these parameters. In the present embodiment, in addition to the force applied by the user in the above equation, virtual repulsion and attraction are taken into consideration to change the damping coefficient D and the spring coefficient K, thereby changing the operating force needed during direct teaching. The operating force may translate to a resistance force or resistance when the hand part of the robot arm body 200 is moved during direct teaching.

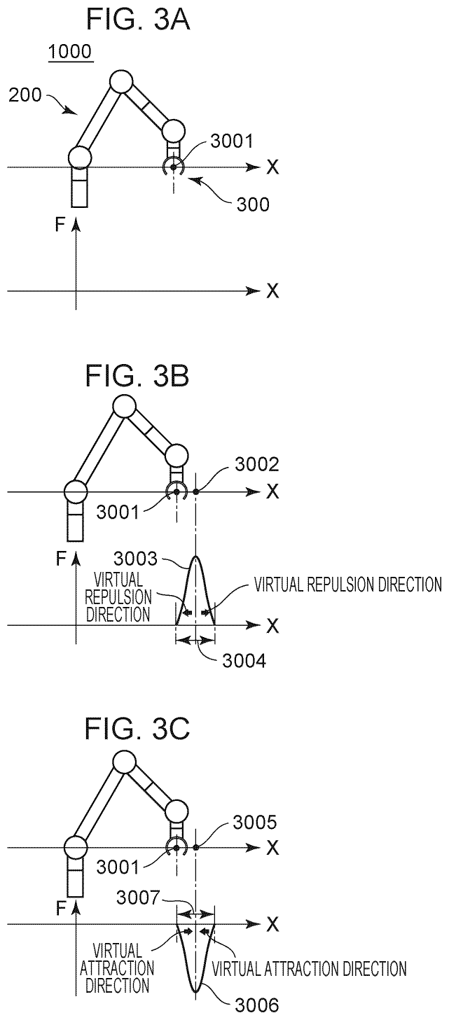

Next, the details of direct teaching in the present embodiment will be described in detail. FIGS. 3A, 3B, and 3C are diagrams for illustrating direct teaching in the present embodiment. A link 205 or the robot hand body 300 may be referred to as a predetermined part. FIG. 3A is a diagram illustrating a virtual coordinate system and a virtual reference coordinate 3001 in a working space of the robot system 1000. FIG. 3B is a diagram where a repulsion field is set in the virtual coordinate system. FIG. 3C is a diagram where an attraction field is set in the virtual coordinate system. FIGS. 3A, 3B, and 3C simply show the robot arm body 200 and the robot hand body 300 in the robot system 1000 described with reference to FIG. 1. The virtual force field is assumed to act at the reference coordinate 3001 and does not act at coordinates other than the reference coordinate 3001 in the robot arm body 200 and the robot hand body 300.

Here, the ordinate axis of each of FIGS. 3A, 3B, and 3C represents a force [N] indicating the magnitude of a force detection value at the hand part of the robot arm body 200, acquired by the force sensors 251 to 256. The abscissa axis is X [m] indicating the position on the X-axis of the hand part of the robot arm body 200. In the present embodiment, an X-axis in one axis direction is set as the virtual coordinate system set in the robot system 1000. The X-axis of the upper diagram in each of FIGS. 3A, 3B, and 3C is the X-axis of the coordinate system virtually set in the robot system 1000, and the lower diagram in each of FIGS. 3A, 3B, and 3C is the X-axis of the coordinate system related to the virtual force field, corresponding to the X-axis. The F-axis is an axis that indicates the strength and direction of a virtual force, showing the strength of repulsion when the force is on the upper side and the strength of attraction when the force is on the lower side. In teaching of a robot, coordinate systems, such as a robot coordinate system, a tool coordinate system, and a user coordinate system, are provided according to the application; however, any coordinate system is applicable, and another coordinate for this teaching may be provided. In the present embodiment, the case where the reference coordinate 3001 is moved in the coordinate system of the entire robot system 1000 will be described as an example.

From FIG. 3A, in direct teaching, the movable range of the robot arm body 200 is limited to a predetermined direction, and furthermore, the user is notified when the hand part of the robot arm body 200 has moved a desired distance. In the present embodiment, the movable range is limited (restricted) to the X-axis direction of the robot system 1000. The reference coordinate 3001 is a reference coordinate used as a reference when virtual repulsion or attraction is acquired. When the reference coordinate 3001 is in proximity to a coordinate, at which virtual repulsion or attraction is generated, as a result of operation of the user, the operating force needed for the user to operate the hand part of the robot arm body 200 changes. The operating force changes by controlling virtual resistance at the time when the user moves the hand part of the robot arm body 200 according to the position of the reference coordinate 3001 and the virtual force field. The virtual force field is considered on the assumption that the working space is a potential field and there are specific coordinates where repulsion or attraction is generated. When those coordinates are in close proximity to the reference coordinate 3001, the operating force needed for the user to operate the robot arm body 200 changes under the influence of virtual repulsion or virtual attraction. These coordinates can be referred to as first positions or second positions.

From FIG. 3B, when the reference coordinate 3001 moves in the +X-axis direction and approaches a virtual repulsion coordinate 3002 where a virtual repulsion potential field 3003 having a virtual repulsion range 3004 is set, the operating force increases due to the virtual repulsion potential field 3003. When the reference coordinate 3001 moves away from the virtual repulsion coordinate 3002, the operating force reduces due to the virtual repulsion potential field 3003. The virtual repulsion potential field 3003 is a range related to the magnitude of virtual repulsion, and is set larger as it approaches the virtual repulsion coordinate 3002. The virtual repulsion range 3004 is a range where virtual repulsion is generated on the X-axis, and is centered on the virtual repulsion coordinate 3002. Actually, virtual repulsion affects the entire working space of the robot system 1000, but it is assumed that as it gets away from the virtual repulsion range 3004 and moves away from the virtual repulsion coordinate 3002, virtual repulsion based on the virtual repulsion potential field 3003 reduces to an ignorable level.

Here, in the present embodiment, the virtual repulsion potential field 3003 and the virtual repulsion range 3004 are changed by the losses of mechanisms such as a speed reducer in the robot arm body 200. Alternatively, a certain range set in advance may be constantly set. As the losses of mechanisms such as a speed reducer increase, the virtual repulsion potential field 3003 and the virtual repulsion range 3004 are reduced, with the result that it is possible to reduce a complete stop of the robot arm body 200 due to a combination of the losses of mechanisms and virtual repulsion.

Thus, when the reference coordinate 3001 approaches and passes through the virtual repulsion coordinate 3002 by the user operating the hand part of the robot arm body 200, a force pushing from the virtual repulsion coordinate 3002 to the reference coordinate 3001 in the −X-axis direction is gradually applied, and the operating force gradually increases. When the reference coordinate 3001 passes through and moves away from the virtual repulsion coordinate 3002 by the user operating the hand part of the robot arm body 200, a force pushing from the virtual repulsion coordinate 3002 to the reference coordinate 3001 in the +X-axis direction is significantly applied, and the operating force steeply reduces.

In this way, the operating force is changed to gradually increase when approaching the virtual repulsion coordinate 3002 and steeply reduce once passing through the virtual repulsion coordinate 3002. By doing this, the user is able to obtain a clicking sensation at a coordinate, where virtual repulsion is set, due to a change in operating force needed to operate the hand part of the robot arm body 200. Thus, it is possible to notify the user of the passage of the virtual repulsion coordinate 3002 through the clicking sensation due to the change in operating force, so it is possible to grasp, through the clicking sensation, how much the robot arm body 200 has been moved.

In the present embodiment, when the operator stops direct teaching (stops operation) while the reference coordinate 3001 is present in the virtual repulsion range 3004, the reference coordinate 3001 is controlled to be pushed from the inside of the virtual repulsion range 3004 to the outside of the virtual repulsion range 3004. In other words, the reference coordinate 3001 is controlled to be positioned at the end of the virtual repulsion range 3004.

From FIG. 3C, when the reference coordinate 3001 moves in the +X-axis direction and approaches a virtual attraction coordinate 3005 where a virtual attraction potential field 3006 having a virtual attraction range 3007 is set, the operating force reduces due to the virtual attraction potential field 3006. When the reference coordinate 3001 moves away from the virtual attraction coordinate 3005, the operating force increases due to the virtual attraction potential field 3006. The virtual attraction potential field 3006 is a range related to the magnitude of virtual attraction, and is set larger as it approaches the virtual attraction coordinate 3005. The virtual attraction range 3007 is a range where virtual attraction is generated on the X-axis, and is centered on the virtual attraction coordinate 3005. Actually, virtual attraction affects the entire working space of the robot system 1000, but it is assumed that as it gets away from the virtual attraction range 3007 and moves away from the virtual attraction coordinate 3005, virtual attraction based on the virtual attraction potential field 3006 reduces to an ignorable level.

Here, in the present embodiment, the virtual attraction potential field 3006 and the virtual attraction range 3007 are changed by the losses of mechanisms such as a speed reducer in the robot arm body 200. Alternatively, a certain range set in advance may be constantly set. As the losses of mechanisms such as a speed reducer increase, the virtual attraction potential field 3006 and the virtual attraction range 3007 are reduced, with the result that it is possible to reduce a complete stop of the robot arm body 200 due to a combination of the losses of mechanisms and virtual attraction.

Thus, when the reference coordinate 3001 approaches and passes through the virtual attraction coordinate 3005 by the user operating the hand part of the robot arm body 200, a force pulling from the virtual attraction coordinate 3005 to the reference coordinate 3001 in the +X-axis direction is gradually applied, and the operating force gradually reduces. When the reference coordinate 3001 passes through and moves away from the virtual attraction coordinate 3005 by the user operating the hand part of the robot arm body 200, a force pulling from the virtual attraction coordinate 3005 to the reference coordinate 3001 in the −X-axis direction is significantly applied, and the operating force steeply increases. In this way, the operating force is changed so as to gradually reduce when approaching the virtual attraction coordinate 3005 and steeply increase once passing through the virtual attraction coordinate 3005.

In the present embodiment, when the operator stops direct teaching (stops operation) while the reference coordinate 3001 is in the virtual attraction range 3007, the reference coordinate 3001 is controlled to be pulled to the virtual attraction coordinate 3005. In other words, the reference coordinate 3001 is controlled so as to be positioned at the virtual attraction coordinate 3005.

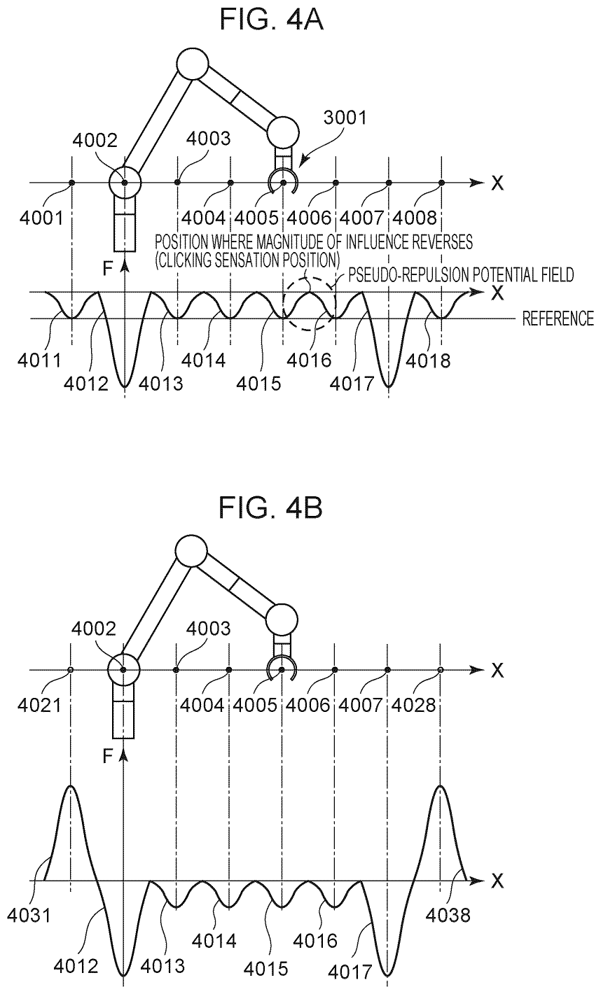

Next, direct teaching in the case where a plurality of virtual repulsion coordinates or a plurality of virtual attraction coordinates is set will be described with reference to FIGS. 4A and 4B. FIG. 4A is a diagram when virtual attraction coordinates are set at equal intervals in the X-axis direction. FIG. 4B is a diagram in which virtual attraction coordinates are placed at equal intervals in the X-axis direction and virtual repulsion coordinates are further placed outside of the virtual attraction coordinates placed at equal intervals.

From FIG. 4A, virtual attraction coordinates 4001 to 4008 are set in the X-axis direction, and virtual attraction potential fields 4011 to 4018 are respectively set at the virtual attraction coordinates 4001 to 4008. The reference coordinate 3001 is at the virtual attraction coordinate 4005. Consider the case of moving the reference coordinate 3001 in this state from the virtual attraction coordinate 4005 to the virtual attraction coordinate 4006. In this case, the magnitude of the influence reverses and the operating force abruptly changes under the influence of the virtual attraction coordinate closer to the reference coordinate 3001 in the process in which the reference coordinate 3001 approaches from the virtual attraction coordinate 4005 to the virtual attraction coordinate 4006. In other words, where attraction at each virtual attraction coordinate is considered as a reference, a pseudo virtual repulsion potential field is set between the virtual attraction coordinates. When the reference coordinate 3001 passes through the position where the magnitude of the influence reverses, the force pulling to the virtual attraction coordinate 4005 changes into the force pulling to the virtual attraction coordinate 4006. In other words, the force pulling in the −X-axis direction changes into the force pushing in the +X-axis direction. Therefore, a user who is moving the hand part in the +X-axis direction can feel an abrupt change in operating force to obtain a clicking sensation.

When the user feels the change in operating force, the user can grasp how many virtual attraction coordinates the reference coordinate 3001 has moved and can grasp how much the robot arm body 200 has moved. The notification of the present embodiment is to notify how much the robot arm body 200 has moved, through a change in operating force in conjunction with the movement of the position of the reference coordinate 3001. Since a virtual attraction potential field is generated at each virtual attraction coordinate, even when the user releases his or her hand from the robot arm body 200, the hand part of the robot arm body 200 is positioned at the virtual attraction coordinate. Therefore, it is possible to reduce the unnecessarily excessive movement of the hand part of the robot arm body 200 although the user does not intend to move the hand, so it is preferable.

In FIG. 4A, the virtual attraction potential fields 4012, 4017 at the virtual attraction coordinates 4002, 4007 are increased compared to the other virtual attraction potential fields. Thus, it is possible to make the user strongly perceive a clicking sensation for each of the five virtual attraction coordinates, and to make the user perceive the passage of the fifth virtual attraction coordinates. Therefore, it is possible to reduce the likelihood that the user erroneously counts the number of virtual attraction coordinates passed. In the present embodiment, five virtual attraction coordinates are applied; however, any number of virtual attraction coordinates may be set.

In FIG. 4B, a virtual repulsion coordinate 4021 is set on the −X-axis side of the virtual attraction coordinate 4002, and a virtual repulsion coordinate 4028 is set on the +X-axis side of the virtual attraction coordinate 4007. Virtual repulsion potential fields 4031, 4038 are respectively set at the virtual repulsion coordinates 4021, 4028.

Thus, it is possible to suppress movement in the −X-axis direction beyond the virtual repulsion coordinate 4021 by the user and also suppress movement in the +X-axis direction beyond the virtual repulsion coordinate 4028 by the user. Thus, for example, if there is an obstacle or the like in the +X-axis direction beyond the virtual repulsion coordinate 4028 and may be brought into contact with the robot, it is possible to make it difficult for the user to operate the robot by virtual repulsion, with the result that it is possible to reduce the contact between the robot and the obstacle. Such repulsion may also be used to, for example, notify the number of coordinates passed.

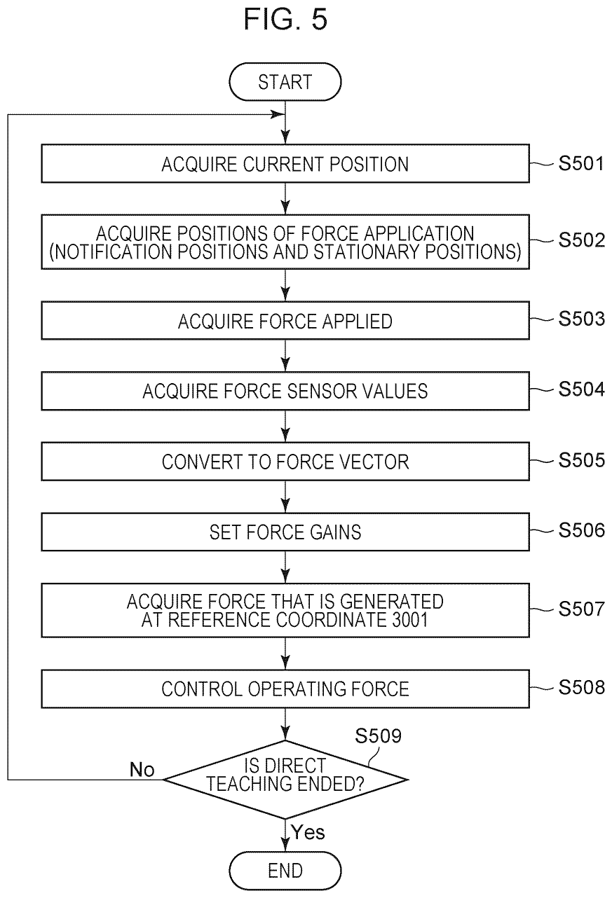

FIG. 5 is a control flowchart in the present embodiment. The control flowchart described with reference to FIG. 5 is executed through the coordination between the CPU 401 of the controller 400 and the CPU mounted at each joint. Here, the virtual attraction coordinates (positions) are defined as stationary positions, and the positions where the magnitude of influence reverses are defined as notification positions. As a premise, it is assumed that virtual coordinates, virtual repulsion fields, virtual attraction fields, stationary positions, and notification positions are set in control of the robot system 1000.

As shown in FIG. 5, initially, in step S501, sensor values are acquired from the encoders (not shown) provided in the motors 211 to 216, to acquire the current position of the reference coordinate 3001. In the present embodiment, the positions of the links 201 to 205 are acquired by the motor encoders. Alternatively, the positions of the links 201 to 205 may be directly detected by using an output shaft ENC that directly detects the positions of the links 201 to 205 or the hand part of the robot arm body 200 may be directly detected by an image capturing apparatus or the like.

Subsequently, in step S502, the positions where a force is applied to the reference coordinate 3001 are acquired based on the current position acquired in step S501 and the notification positions and stationary positions set in advance. In the present embodiment, information about virtual coordinates, notification positions, stationary positions, and virtual repulsion and attraction information on virtual repulsion and attraction set at those positions is stored in a simulator storing the robot system 1000 as a model. Then, the information about the positions where a force is applied to the reference coordinate 3001 (the notification positions and the stationary positions) is acquired from the simulator. In the present embodiment, a simulator is used. Alternatively, various formats of data storing information about virtual coordinates, notification positions, stationary positions, and virtual repulsion and attraction set at those positions may be used.

Subsequently, in step S503, the force that is currently applied to the reference coordinate 3001 is acquired based on the current position of the reference coordinate 3001 and the information about the notification positions and the stationary positions. Subsequently, in step S504, the force applied by the user to the hand part of the robot arm body 200 is acquired from the values of the force sensors 251 to 256.

Subsequently, in step S505, the forces in the respective axis directions (XYZ) at the reference coordinate 3001 are acquired based on the values of the force sensors 251 to 256. In the present embodiment, the forces in the respective axis directions (XYZ) at the predetermined position of the link 205 are acquired based on the values of the force sensors 251 to 256 and the link parameters of the robot arm body 200. Then, the forces in the respective axis directions (XYZ) at the predetermined position of the link 205 are acquired as the forces in the respective axis directions (XYZ) at the reference coordinate 3001. This is because the link 205 that is the distal end link as the hand part of the robot arm body 200 is easy for the user to perform direct teaching. Of course, when the robot hand body 300 is operated to perform direct teaching, the forces in the respective axis directions (XYZ) at a predetermined position in the robot hand body 300 may be acquired. In that case, the forces in the respective axis directions (XYZ) are acquired from the values of the force sensors 251 to 256, the link parameters of the robot arm body 200, and the shape parameters of the robot hand body 300.

In the subsequent step S506, gains of the forces in directions other than a specific axis direction are set to zero such that the reference coordinate 3001 operates in the specific axis direction. In the present embodiment, the hand part of the robot arm body 200 is controlled to move in the X-axis direction at the reference coordinate 3001. Thus, in step S506, the gains of the forces in the Y direction and Z direction of the robot arm body 200 are set to zero in the XYZ coordinate system. In the present embodiment, the hand part of the robot arm body 200 is controlled to move in the X direction. Alternatively, the hand part of the robot arm body 200 may be moved in the Y direction or may be moved in the Z direction.

In the subsequent step S507, the force generated at the reference coordinate 3001 is acquired based on the forces that are applied to the reference coordinate 3001 from the virtual repulsion potential fields and/or virtual attraction potential fields set at the notification positions and the stationary positions, and the force applied from the user. Then, in step S508, the damping coefficient D and the spring coefficient K are changed using the force generated at the reference coordinate 3001 and acquired in step S507 as input, and the operating force needed to operate the hand part of the robot arm body 200 is controlled. Thus, it is possible to notify the user of a clicking sensation due to virtual attraction and/or virtual repulsion through a change in the operating force.

Then, in step S509, it is determined whether the user has provided instructions to end direct teaching. When the user has not provided instructions to end direct teaching, the determination in step S509 is negative, the process returns to step S501, and the above-described control flowchart is repeated. When the user has provided instructions to end direct teaching, the determination in step S509 is affirmative, and the control flowchart ends.

According to the above-described present embodiment, the position of the robot is notified to the user by changing the operating force needed when the user directly operates the robot. Thus, the user is able to operate the robot while grasping the coordinate during operation (while grasping how much the robot arm body 200 or the robot hand body 300 has moved). Thus, for example, it is possible to make the user intuitively grasp the position of the hand part of the robot arm body 200 while the user is performing direct teaching, with the result that it is possible to improve the operability of robot operation by the user.

### Second Embodiment

Next, the second embodiment will be described in detail. In the first embodiment, an example of the case where the direction in which the reference coordinate 3001 moves is defined as a predetermined one-axis direction (X direction) will be described. In the second embodiment, an example of the case where the direction in which the reference coordinate 3001 moves is defined as a plurality of axes, that is, X and Y-axes, X, Y, and Z-axes, or the like will be described. In teaching of a robot, a coordinate system, such as a robot coordinate system, a tool coordinate system, and a user coordinate system, is provided according to the application; however, any coordinate system is applicable, and another coordinate for this teaching may be provided. In the present embodiment, the case where the reference coordinate 3001 is moved in the coordinate system of the entire robot system 1000 will be described as an example. In the following description, the portions of the configuration of the hardware and control system, different from those of the first embodiment, will be described with reference to the drawings. Similar portions to those of the first embodiment have the same configuration and function as described above, and the detailed description thereof is omitted.

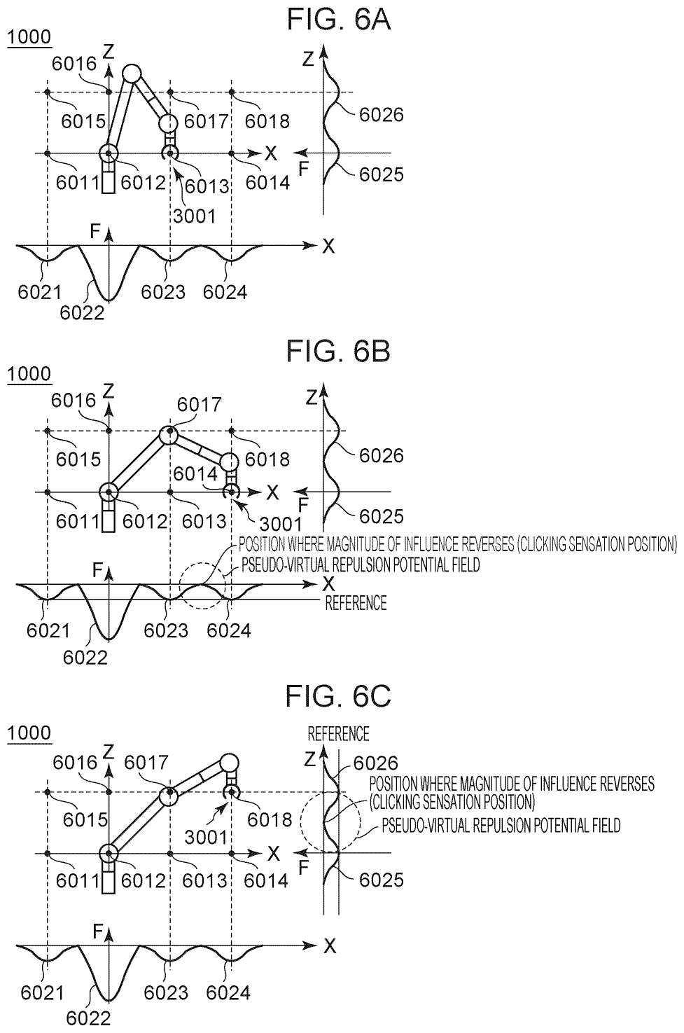

FIGS. 6A, 6B, and 6C are diagrams for illustrating direct teaching in the present embodiment. FIG. 6A is a diagram illustrating a virtual coordinate system, a virtual reference coordinate 3001, and virtual force fields in a working space of the robot system 1000 in an XZ plane. FIG. 6B is a diagram when the reference coordinate 3001 has been moved in the +X-axis direction from the state of FIG. 6A. FIG. 6C is a diagram when the reference coordinate 3001 has been moved in the +Z-axis direction from the state of FIG. 6B. FIGS. 6A, 6B, and 6C simply show the robot arm body 200 and the robot hand body 300 in the robot system 1000 described with reference to FIG. 1.

From FIG. 6A, in direct teaching, the movable range of the robot arm body 200 is limited to a predetermined direction, and furthermore, the user is notified when the hand part of the robot arm body 200 has moved a desired distance. In the present embodiment, the movable range is limited to the X-axis direction and Z-axis direction of the robot system 1000. In other words, in the present embodiment, when the reference coordinate 3001 is moved from the state of FIG. 6A, movement to virtual attraction coordinates 6012, 6014, 6017 is allowed, and movement to virtual attraction coordinates 6016, 6018 present in the directions in the XZ plane is not allowed.

Subsequently, the reference coordinate 3001 is a reference coordinate used as a reference when virtual repulsion or attraction is acquired. When the reference coordinate 3001 is in proximity to a coordinate, at which virtual repulsion or attraction is generated, as a result of operation of the user, the operating force needed for the user to operate the hand part of the robot arm body 200 changes. The operating force changes by controlling virtual resistance at the time when the user moves the hand part of the robot arm body 200 according to the position of the reference coordinate 3001 and the virtual force field. The virtual force field is considered on the assumption that the working space is a potential field and there are specific coordinates where repulsion or attraction is generated. When those coordinates are in close proximity to the reference coordinate 3001, the operating force needed for the user to operate the robot arm body 200 changes under the influence of virtual repulsion or virtual attraction.

From FIG. 6A, virtual attraction coordinates 6011, 6012, 6013, 6014 are set in the X-axis direction. Furthermore, virtual attraction coordinates 6015, 6016, 6017, 6018 are set on the X-axis shifted by a predetermined amount in the +Z-axis direction from the X-axis where the virtual attraction coordinates 6011, 6012, 6013, 6014 are set. The state of FIG. 6A is a state where the reference coordinate 3001 is positioned at the virtual attraction coordinate 6013. These coordinates can be referred to as first positions or second positions.

Virtual attraction potential fields 6021, 6022, 6023, 6024 are set in the X-axis direction. The virtual attraction potential field 6022 is larger than the other virtual attraction potential fields 6021, 6023, 6024. Virtual repulsion potential fields 6025, 6026 are set in the Z-axis direction. The basic matters of the virtual attraction potential field and virtual attraction range in the present embodiment are similar to those of the first embodiment, so the description is omitted.

As shown in FIG. 6B, when the reference coordinate 3001 in the state of FIG. 6A is moved from the virtual attraction coordinate 6013 to the virtual attraction coordinate 6014, the reference coordinate 3001 is influenced by the virtual attraction coordinate closer to the reference coordinate 3001. Then, in the process in which the reference coordinate 3001 approaches from the coordinate 6013 to the coordinate 6014, the magnitude of the influence reverses, and the operating force abruptly changes. In other words, where attraction at each virtual attraction coordinate is considered as a reference, a pseudo virtual repulsion potential field is set between the virtual attraction coordinates. When the reference coordinate 3001 passes through the position where the magnitude of the influence reverses, the force pulling to the virtual attraction coordinate 6013 changes into the force pulling to the virtual attraction coordinate 6014. In other words, the force pulling in the −X-axis direction changes into the force pushing in the +X-axis direction. Therefore, a user who is moving the hand part in the +X-axis direction can feel an abrupt change in operating force to obtain a clicking sensation.

As shown in FIG. 6C, when the reference coordinate 3001 in the state of FIG. 6B is moved from the virtual attraction coordinate 6014 to the virtual attraction coordinate 6018, the reference coordinate 3001 is influenced by the virtual attraction coordinate closer to the reference coordinate 3001. Then, in the process in which the reference coordinate 3001 approaches from the coordinate 6014 to the coordinate 6018, the magnitude of the influence reverses, and the operating force abruptly changes. In other words, where attraction at each virtual attraction coordinate is considered as a reference, a pseudo virtual repulsion potential field is set between the virtual attraction coordinates. When the reference coordinate 3001 passes through the position where the magnitude of the influence reverses, the force pulling to the virtual attraction coordinate 6014 changes into the force pulling to the virtual attraction coordinate 6018. In other words, the force pulling in the −Z-axis direction changes into the force pushing in the +Z-axis direction. Therefore, a user who is moving the hand part in the +Z-axis direction can feel an abrupt change in operating force to obtain a clicking sensation.

When the user feels the change in operating force, the user can grasp how many virtual attraction coordinates the reference coordinate 3001 has moved in each axis and can grasp how much the robot arm body 200 has moved. The notification of the present embodiment is to notify how much the robot arm body 200 has moved, through a change in operating force in conjunction with the movement of the position of the reference coordinate 3001. Since a virtual attraction potential field is generated at each virtual attraction coordinate, even when the user releases his or her hand from the robot arm body 200, the hand part of the robot arm body 200 is positioned at the virtual attraction coordinate. Therefore, it is possible to reduce the unnecessarily excessive movement of the hand part of the robot arm body 200 although the user does not intend to move the hand, so it is preferable.

In FIG. 6A, the virtual attraction potential field 6022 is increased compared to the other virtual attraction potential fields. Thus, it is possible to make the user strongly perceive a clicking sensation for each of a predetermined number of virtual attraction coordinates, and to make the user perceive the passage of the predetermined number of virtual attraction coordinates. Therefore, it is possible to reduce the likelihood that the user erroneously counts the number of virtual attraction coordinates passed. In the present embodiment, the predetermined virtual attraction potential field in the X-axis direction is increased. Alternatively, a predetermined virtual attraction potential field in the Z-axis direction may be increased.

At the virtual attraction coordinates 6012, 6016, the virtual attraction potential field 6022 is set in the X-axis direction, and the virtual attraction potential fields 6025, 6026 are set in the Z-axis direction. Although the virtual attraction potential field 6022 is larger than the virtual attraction potential fields 6025, 6026, all of the virtual attraction potential fields are forces that attempt to position the reference coordinate 3001 at the virtual attraction coordinate 6012 or the virtual attraction coordinate 6016. Therefore, even when the magnitude of the potential field of a virtual force varies in the axial direction, the reference coordinate 3001 does not shift from each virtual attraction coordinate in the state where the user is not moving the hand part of the robot arm body 200.

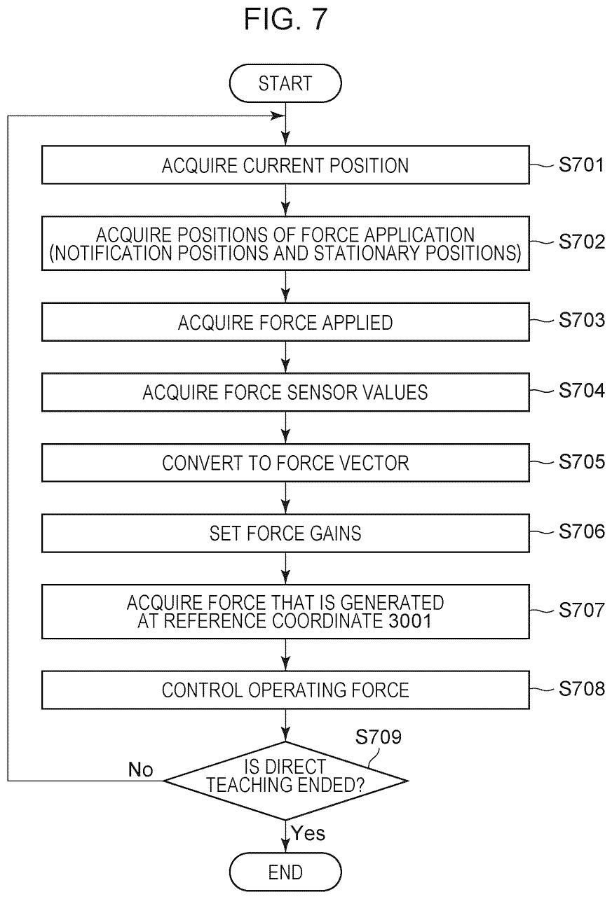

FIG. 7 is a control flowchart in the present embodiment. The control flowchart described with reference to FIG. 7 is executed through the coordination between the CPU 401 of the controller 400 and the CPU mounted at each joint. Here, the virtual attraction coordinates (positions) are defined as stationary positions, and the positions where the magnitude of influence reverses are defined as notification positions. As a premise, it is assumed that virtual coordinates, virtual repulsion fields, virtual attraction fields, stationary positions, and notification positions are set in control of the robot system 1000.

As shown in FIG. 7, initially, in step S701, sensor values are acquired from the encoders (not shown) provided in the motors 211 to 216, to acquire the current position of the reference coordinate 3001. In the present embodiment, the positions of the links 201 to 205 are acquired by the motor encoders. Alternatively, the positions of the links 201 to 205 may be directly detected by using an output shaft ENC that directly detects the positions of the links 201 to 205 or the hand part of the robot arm body 200 may be directly detected by an image capturing apparatus or the like.

Subsequently, in step S702, the positions where a force is applied to the reference coordinate 3001 are acquired based on the current position acquired in step S701 and the notification positions and stationary positions set in advance. In the present embodiment, information about virtual coordinates, notification positions, stationary positions, and virtual repulsion and attraction information on virtual repulsion and attraction set at those positions is stored in a simulator storing the robot system 1000 as a model. Then, the information about the positions where a force is applied to the reference coordinate 3001 (the notification positions and the stationary positions) is acquired from the simulator. In the present embodiment, a simulator is used. Alternatively, various formats of data storing information about virtual coordinates, notification positions, stationary positions, and virtual planned repulsion and attraction set at those positions may be used.

Subsequently, in step S703, the force that is currently applied to the reference coordinate 3001 is acquired based on the current position of the reference coordinate 3001 and the information about the notification positions and the stationary positions. The difference from the first embodiment is that virtual force in the X-axis direction and virtual force in the Z-axis direction are taken into consideration. Subsequently, in step S704, the force applied by the user to the hand part of the robot arm body 200 is acquired from the values of the force sensors 251 to 256.

Subsequently, in step S705, the forces in the respective axis directions (XYZ) at the reference coordinate 3001 are acquired based on the values of the force sensors 251 to 256. In the present embodiment, the forces in the respective axis directions (XYZ) at the predetermined position of the link 205 are acquired based on the values of the force sensors 251 to 256 and the link parameters of the robot arm body 200. Then, the forces in the respective axis directions (XYZ) at the predetermined position of the link 205 are acquired as the forces in the respective axis directions (XYZ) at the reference coordinate 3001. This is because the link 205 that is the distal end link as the hand part of the robot arm body 200 is easy for the user to perform direct teaching. Of course, when the robot hand body 300 is operated to perform direct teaching, the forces in the respective axis directions (XYZ) at a predetermined position in the robot hand body 300 may be acquired. In that case, the forces in the respective axis directions (XYZ) are acquired from the values of the force sensors 251 to 256, the link parameters of the robot arm body 200, and the shape parameters of the robot hand body 300.

In the subsequent step S706, gains of the forces in directions other than a specific axis direction are set to zero such that the reference coordinate 3001 operates in the specific axis direction. In the present embodiment, the hand part of the robot arm body 200 is controlled to move in the X-axis direction and the Z-axis direction at the reference coordinate 3001. Thus, in step S706, the gain of the force in the Y direction of the robot arm body 200 is set to zero in the XYZ coordinate system.

In the subsequent step S707, the force generated at the reference coordinate 3001 is acquired based on the forces that are applied to the reference coordinate 3001 from the virtual repulsion potential fields and/or virtual attraction potential fields in each direction, set at the notification positions and the stationary positions, and the force applied from the user. Then, in step S708, the damping coefficient D and the spring coefficient K are changed using the force generated at the reference coordinate 3001 and acquired in step S707 as input, and the operating force needed to operate the hand part of the robot arm body 200 is controlled. Thus, it is possible to notify the user of a clicking sensation due to virtual attraction and/or virtual repulsion through a change in the operating force.

Then, in step S709, it is determined whether the user has provided instructions to end direct teaching. When the user has not provided instructions to end direct teaching, the determination in step S709 is negative, the process returns to step S701, and the above-described control flowchart is repeated. When the user has provided instructions to end direct teaching, the determination in step S709 is affirmative, and the control flowchart ends.

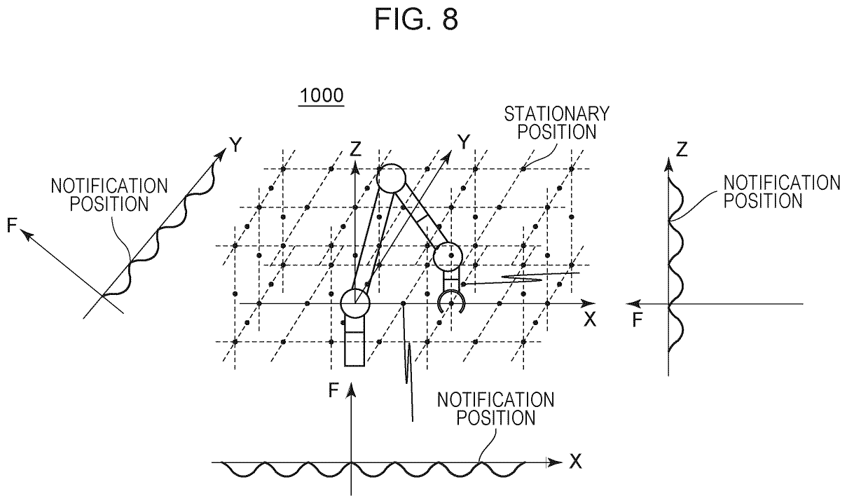

In the present embodiment, the case where movement in the X-axis direction and Z-axis direction is allowed has been described. Alternatively, as shown in FIG. 8, coordinates (stationary positions) where virtual attraction or repulsion is generated in the X-axis direction, Y-axis direction, and Z-axis direction may be set, and a clicking sensation may be generated in each axis direction.

The positions where the clicking sensation is generated are notification positions set for each axis as described above. It should be noted that, for the sake of simplification of illustration, FIG. 8 is not a diagram in which coordinates where attraction or repulsion is generated do not correspond in detail to the potential fields of virtual forces in each axis direction. In actual control, the coordinates (stationary positions) where virtual attraction or repulsion is generated are set so as to correspond to the potential fields of virtual forces.

According to the above-described present embodiment, the position of the robot is notified to the user by changing the operating force in a plurality of axes, needed when the user directly operates the robot. Thus, the user is able to operate the robot while grasping the coordinate during operation (while grasping how much the robot arm body 200 or the robot hand body 300 has moved). Thus, for example, it is possible to make the user intuitively grasp the position of the robot while the user is performing direct teaching, with the result that it is possible to improve the operability of robot operation by the user. The above-described various embodiments and modifications may be implemented in combination with the present embodiment and/or the present modification.

### Third Embodiment

Next, the third embodiment will be described in detail. In the third embodiment, a mode in which the strength of the virtual force applied from a stationary position or a notification position is changed depending on the movable direction of the robot during direct teaching will be described. In teaching of a robot, coordinates, such as a robot coordinate system, a tool coordinate system, and a user coordinate system, are provided according to the application; however, any coordinate system is applicable, and another coordinate for this teaching may be provided. In the present embodiment, the case where the reference coordinate 3001 is moved in the coordinate system of the entire robot system 1000 will be described as an example. In the following description, the portions of the configuration of the hardware and control system, different from those of the above-described various embodiments, will be described with reference to the drawings. Similar portions to those of the above-described various embodiments have the same configuration and function as described above, and the detailed description thereof is omitted.

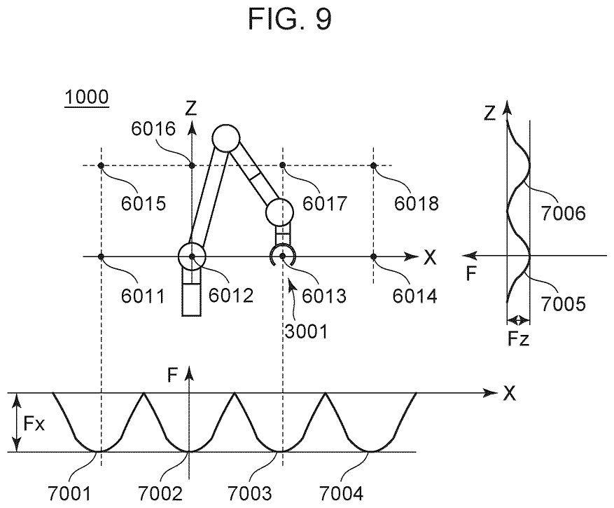

FIG. 9 is a diagram for illustrating direct teaching in the present embodiment. FIG. 9 is a diagram illustrating a virtual coordinate system, a virtual reference coordinate 3001, and virtual force fields in a working space of the robot system 1000 in an XZ plane. FIG. 9 simply shows the robot arm body 200 and the robot hand body 300 in the robot system 1000 described with reference to FIG. 1. In FIG. 9, for the sake of ease illustration, the case of two axes, that is, the X-axis direction and the Z-axis direction, will be described; however, it is also applicable to three axes, that is, the X-axis direction, the Y-axis direction, and the Z-axis direction, as shown in FIG. 8.

From FIG. 9, virtual attraction coordinates 6011, 6012, 6013, 6014 are set in the X-axis direction. Furthermore, virtual attraction coordinates 6015, 6016, 6017, 6018 are set on the X-axis shifted by a predetermined amount in the +Z-axis direction from the X-axis where the virtual attraction coordinates 6011, 6012, 6013, 6014 are set. The state of FIG. 9 is a state where the reference coordinate 3001 is positioned at the virtual attraction coordinate 6013. These coordinates can be referred to as first positions or second positions.

Virtual attraction potential fields 7001, 7002, 7003, 7004 are set in the X-axis direction. Virtual attraction potential fields 7005, 7006 are set in the Z-axis direction. As shown in FIG. 9, in the present embodiment, the virtual attraction potential fields set in the X-axis direction are increased compared to the virtual attraction potential fields set in the Z-axis direction. Where the virtual attraction potential field in the X-axis direction is denoted as Fx and the virtual attraction potential field in the Z-axis direction is denoted as Fz, Fx>Fz. In other words, when the reference coordinate 3001 is moved, the force needed to move in the X-axis direction is larger than the force needed to move in the Z-axis direction.

The virtual attraction potential fields set in the X-axis direction are different in magnitude from the virtual attraction potential fields set in the Z-axis direction. However, each of the virtual attraction potential fields is a force that attempts to position the reference coordinate 3001 at the corresponding virtual attraction coordinate. Therefore, even when the magnitude of the potential field of a virtual force varies in the axial direction, the reference coordinate 3001 does not shift from each virtual attraction coordinate in the state where the user is not moving the hand part of the robot arm body 200. The basic matters of the virtual attraction potential field and virtual attraction range in the present embodiment are similar to those of the above-described various embodiments, so the description is omitted.

In the present embodiment described above, it is possible to move in the X-axis direction with a large force in consideration of fine adjustments between coordinates and to significantly move in the Z-axis direction with a small force. When the operating force needed for movement for each coordinate (unit) is large, a certain amount of operating force is needed even for slight movement like fine adjustments by reducing the interval between coordinates (making the interval finer). Therefore, it is possible to make fine adjustments without delicate adjustments of the applied force, and it is possible to reduce the unnecessary movement of the robot although fine adjustments are intended, so it is suitable. On the other hand, when the operating force needed for movement for each coordinate (unit) is small, it is possible to move between coordinates with a small force, so it is possible to move with a small force also at the time of moving a long distance and it is possible to reduce burden on the user, so it is suitable. Therefore, when the operating force needed for movement is changed according to the direction to be moved, it is possible to achieve fine position adjustments and reduction of load of movement in a predetermined direction, so it is possible to improve the operability of robot operation by the user. The above-described various embodiments and modifications may be implemented in combination with the present embodiment and/or the present modification.

### Fourth Embodiment

Next, the fourth embodiment will be described in detail. In the fourth embodiment, a mode in which the strength of the force applied from a stationary position or a notification position in each axis direction is switched based on the direction in which the robot arm body 200 is moved will be described. In teaching of a robot, coordinates, such as a robot coordinate system, a tool coordinate system, and a user coordinate system, are provided according to the application; however, any coordinate system is applicable, and another coordinate for this teaching may be provided. In the present embodiment, the case where the reference coordinate 3001 is moved in the coordinate system of the entire robot system 1000 will be described as an example. In the following description, the portions of the configuration of the hardware and control system, different from those of the above-described various embodiments, will be described with reference to the drawings. Similar portions to those of the above-described various embodiments have the same configuration and function as described above, and the detailed description thereof is omitted.

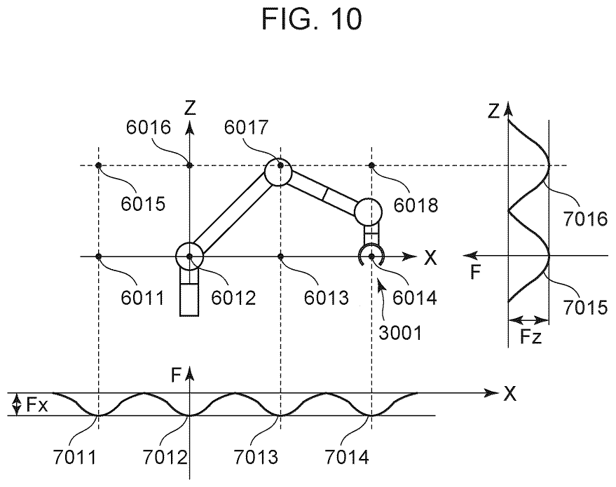

FIG. 10 is a diagram for illustrating direct teaching in the present embodiment. FIG. 10 is a diagram of the case where the reference coordinate 3001 has been moved from the state of FIG. 9 to the virtual attraction coordinate 6014. The positions of the virtual attraction coordinates set in FIGS. 9 and 10 are the same. The present embodiment differs from the above-described various embodiments in that the virtual attraction potential fields in the X-axis direction and the virtual attraction potential fields in the Z-axis direction are switched based on the movement of the reference coordinate 3001. FIG. 10 simply shows the robot arm body 200 and the robot hand body 300 in the robot system 1000 described with reference to FIG. 1. In FIG. 10, for the sake of ease illustration, the case of two axes, that is, the X-axis direction and the Z-axis direction, will be described; however, it is also applicable to three axes, that is, the X-axis direction, the Y-axis direction, and the Z-axis direction, as shown in FIG. 8.

As shown in FIG. 10, when the reference coordinate 3001 has been moved from the state of FIG. 9 to the virtual attraction coordinate 6014, virtual attraction potential fields 7011, 7012, 7013, 7014 are set in the X-axis direction, and virtual attraction potential fields 7015, 7016 are set in the Z-axis direction. As shown in FIG. 10, in the present embodiment, the virtual attraction potential fields set in the X-axis direction are reduced compared to the virtual attraction potential fields set in the Z-axis direction. Where the virtual attraction potential field in the X-axis direction is denoted as Fx and the virtual attraction potential field in the Z-axis direction is denoted as Fz, Fz>Fx. In the present embodiment, it is assumed that, before reaching the state of FIG. 9, the reference coordinate 3001 is at the virtual attraction coordinate 6012 and then the reference coordinate 3001 has moved in the +X-axis direction to the virtual attraction coordinate 6013.

In other words, in the present embodiment, when the reference coordinate 3001 moves consecutively in the axis direction in which the reference coordinate 3001 has moved immediately before (the reference coordinate 3001 moves in the same direction consecutively at least twice), the operating force needed for movement in the axis direction is switched so as to be smaller than those in the other axis directions. In the case of the present embodiment, since the reference coordinate 3001 moves at least twice in the +X-axis direction, the operating force needed for movement in the X-axis direction is reduced. This makes it easier to move in the axis direction in which the user considers to actively move, so it is suitable. In the present embodiment, when the reference coordinate 3001 moves consecutively in the +X-axis direction (the reference coordinate 3001 moves in the same direction consecutively at least twice), the operating force is reduced. Alternatively, the operating force may be reduced when the reference coordinate 3001 moves consecutively in the −X-axis direction (the reference coordinate 3001 moves in the same direction consecutively at least twice).

The operating force may be reduced when the reference coordinate 3001 has been moved once in the +X-axis direction and then moved once in the −X-axis direction. However, when the reference coordinate 3001 is moving alternately in the + direction or in the − direction, there is a high possibility that the user is making fine adjustments, so it is preferable to reduce the operating force when the reference coordinate 3001 consecutively moves in the +X-axis direction (or −X-axis direction) (the reference coordinate 3001 moves in the same direction consecutively at least twice). The same applies in the Z-axis direction. In the case of three axes, for example, when the reference coordinate 3001 consecutively moves in the X-axis direction, where the virtual attraction potential field in the X-axis direction is denoted as Fx, the virtual attraction potential field in the Y-axis direction is defined as Fy, and the virtual attraction potential field in the Z-axis direction is denoted as Fz, it is sufficient to ensure that Fz, Fy>Fx.

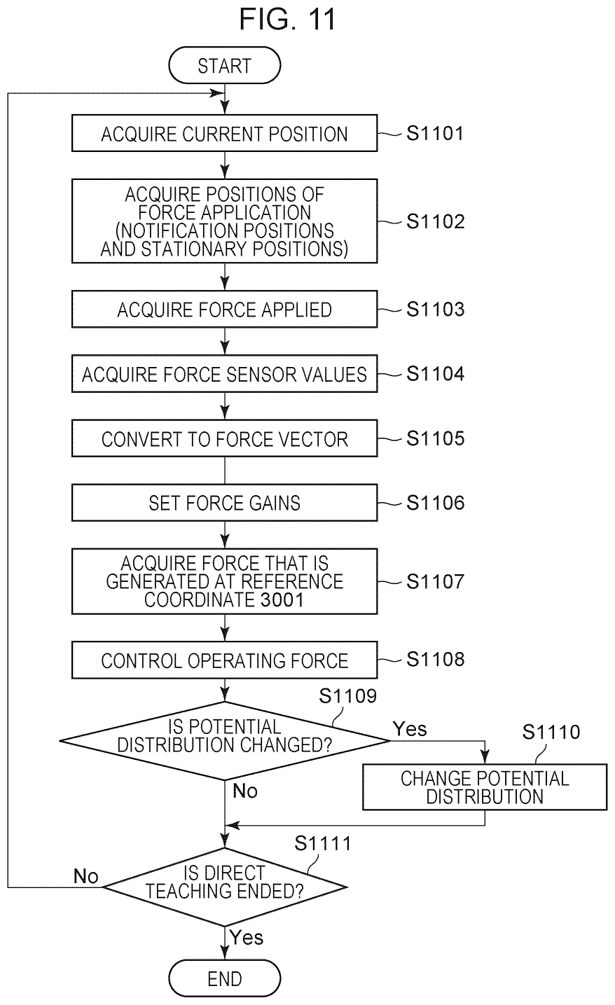

FIG. 11 is a control flowchart in the present embodiment. The control flowchart described with reference to FIG. 11 is executed through the coordination between the CPU 401 of the controller 400 and the CPU mounted at each joint. Here, the virtual attraction coordinates (positions) are defined as stationary positions, and the positions where the magnitude of influence reverses are defined as notification positions. As a premise, it is assumed that virtual coordinates, virtual repulsion fields, virtual attraction fields, stationary positions, and notification positions are set in control of the robot system 1000.

As shown in FIG. 11, initially, in step S1101, sensor values are acquired from the encoders (not shown) provided in the motors 211 to 216, to acquire the current position of the reference coordinate 3001. In the present embodiment, the positions of the links 201 to 205 are acquired by the motor encoders. Alternatively, the positions of the links 201 to 205 may be directly detected by using an output shaft ENC that directly detects the positions of the links 201 to 205 or the hand part of the robot arm body 200 may be directly detected by an image capturing apparatus or the like.

Subsequently, in step S1102, the positions where a force is applied to the reference coordinate 3001 are acquired based on the current position acquired in step S1101 and the notification positions and stationary positions set in advance. In the present embodiment, information about virtual coordinates, notification positions, stationary positions, and virtual repulsion and attraction information on virtual repulsion and attraction set at those positions is stored in a simulator storing the robot system 1000 as a model. Then, the information about the positions where a force is applied to the reference coordinate 3001 (the notification positions and the stationary positions) is acquired from the simulator. In the present embodiment, a simulator is used. Alternatively, various formats of data storing information about virtual coordinates, notification positions, stationary positions, and virtual planned repulsion and attraction set at those positions may be used.

Subsequently, in step S1103, the force that is currently applied to the reference coordinate 3001 is acquired based on the current position of the reference coordinate 3001 and the information about the notification positions and the stationary positions. In step S1103, virtual forces in the X-axis direction and the Z-axis direction are taken into consideration. Subsequently, in step S1104, the force applied by the user to the hand part of the robot arm body 200 is acquired from the values of the force sensors 251 to 256.

Subsequently, in step S1105, the forces in the respective axis directions (XYZ) at the reference coordinate 3001 are acquired based on the values of the force sensors 251 to 256. In the present embodiment, the forces in the respective axis directions (XYZ) at the predetermined position of the link 205 are acquired based on the values of the force sensors 251 to 256 and the link parameters of the robot arm body 200. Then, the forces in the respective axis directions (XYZ) at the predetermined position of the link 205 are acquired as the forces in the respective axis directions (XYZ) at the reference coordinate 3001. This is because the link 205 that is the distal end link as the hand part of the robot arm body 200 is easy for the user to perform direct teaching. Of course, when the robot hand body 300 is operated to perform direct teaching, the forces in the respective axis directions (XYZ) at a predetermined position in the robot hand body 300 may be acquired. In that case, the forces in the respective axis directions (XYZ) are acquired from the values of the force sensors 251 to 256, the link parameters of the robot arm body 200, and the shape parameters of the robot hand body 300.

In the subsequent step S1106, gains of the forces in directions other than a specific axis direction are set to zero such that the reference coordinate 3001 operates in the specific axis direction. In the present embodiment, the hand part of the robot arm body 200 is controlled to move in the X-axis direction and the Z-axis direction at the reference coordinate 3001. Thus, in step S1106, the gain of the force in the Y direction of the robot arm body 200 is set to zero in the XYZ coordinate system.

In the subsequent step S1107, the force generated at the reference coordinate 3001 is acquired based on the forces that are applied to the reference coordinate 3001 from the virtual repulsion potential fields and/or virtual attraction potential fields in each direction, set at the notification positions and the stationary positions, and the force applied from the user. Then, in step S1108, the damping coefficient D and the spring coefficient K are changed using the force generated at the reference coordinate 3001 and acquired in step S1107 as input, and the operating force needed to operate the hand part of the robot arm body 200 is controlled. Thus, it is possible to notify the user of a clicking sensation due to virtual attraction and/or virtual repulsion through a change in the operating force.

Then, in step S1109, it is determined whether the potential distribution of the virtual attraction potential fields is changed in a specific axis direction. In the present embodiment, when the reference coordinate 3001 has moved consecutively in a specific axis direction (when the reference coordinate 3001 has moved at least twice), the magnitude of the virtual attraction potential field in the specific axis direction is made smaller than the magnitudes of the virtual attraction potential fields in the other axis directions. In the present embodiment, it is defined as at least two consecutive movements; however, any number may be set. When the determination is affirmative in S1109, the process proceeds to S1110, and the magnitude of the virtual attraction potential field in the specific axis direction is reduced compared to the virtual attraction potential fields in the other axis directions. Then, the process proceeds to step S1111. When the determination is negative in step S1109, the process proceeds to step S1111 without changing the potential distribution of the potential fields.

Then, in step S1111, it is determined whether the user has provided instructions to end direct teaching. When the user has not provided instructions to end direct teaching, the determination in step S1111 is negative, the process returns to step S1101, and the above-described control flowchart is repeated. When the user has provided instructions to end direct teaching, the determination in step S1111 is affirmative, and the control flowchart ends.

According to the present embodiment described above, it is possible to easily move the robot in the axis direction in which the user considers to actively move the robot. Therefore, it is possible to reduce the burden on the user and improve the operability of robot operation by the user. The above-described various embodiments and modifications may be implemented in combination with the present embodiment and/or the present modification.

### Fifth Embodiment

Next, the fifth embodiment will be described in detail. In the fifth embodiment, in the case where a predetermined joint of the robot arm body 200 is moved, the case where the amount of movement (the amount of rotation) of the predetermined joint is notified to the user through a clicking sensation will be described. In teaching of a robot, coordinates, such as a robot coordinate system, a tool coordinate system, and a user coordinate system, are provided according to the application; however, any coordinate system is applicable, and another coordinate for this teaching may be provided. In the present embodiment, an example of the case where a rotating coordinate system at the joint J2 in movement of a reference coordinate 1201 (described later) will be described. In the following description, the portions of the configuration of the hardware and control system, different from those of the above-described various embodiments, will be described with reference to the drawings. Similar portions to those of the above-described various embodiments have the same configuration and function as described above, and the detailed description thereof is omitted.

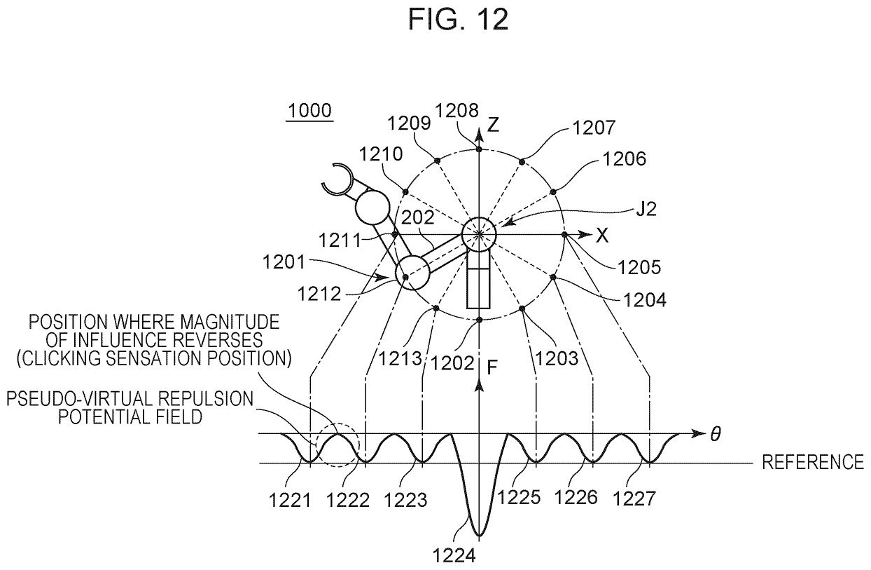

FIG. 12 is a diagram for illustrating direct teaching in the present embodiment. FIG. 12 is a diagram illustrating a virtual coordinate system, the virtual reference coordinate 1201, and virtual force fields in the rotation range of the joint J2 in a θ-axis direction that is the rotation direction of the joint J2. FIG. 12 simply shows the robot arm body 200 and the robot hand body 300 in the robot system 1000 described with reference to FIG. 1. In the present embodiment, the joint J2 will be described in detail in an example; however, similar control can also be executed for the other joints. The joint J2 can be referred to as a predetermined part.

From FIG. 12, in direct teaching, the user is notified when the joint J2 has moved a desired distance (angle). The reference coordinate 1201 is a reference coordinate used as a reference when virtual repulsion or attraction is acquired. When the reference coordinate 1201 is in proximity to a coordinate at which virtual repulsion or attraction is generated as a result of operation of the user, the operating force needed for the user to operate the link 202 connected to the joint J2 changes. The operating force changes by controlling virtual resistance at the time when the user moves the link 202 according to the position of the reference coordinate 1201 and the virtual force fields. The virtual force fields are considered on the assumption that the rotation range of the joint J2 is a potential field and there are specific coordinates where repulsion or attraction is generated. When those coordinates are in proximity to the reference coordinate 1201, the operating force needed for the user to operate the link 202 is changed under the influence of virtual repulsion or virtual attraction.

From FIG. 12, virtual attraction coordinates 1202 to 1213 are set in the θ-axis direction. The state of FIG. 12 is a state where the reference coordinate 1201 is positioned at the virtual attraction coordinate 1212. From FIG. 12, virtual attraction potential fields are set in the axis direction. For the sake of convenience of description, FIG. 12 shows virtual attraction potential fields 1221 to 1227; however, it is assumed that corresponding virtual attraction potential fields are set at all virtual attraction coordinates 1202 to 1213. The virtual attraction potential field 1224 and the virtual attraction potential field (not shown) set at the virtual attraction coordinate 1208 are set so as to be larger than the other virtual attraction potential fields. The basic matters of the virtual attraction potential field and virtual attraction range in the present embodiment are similar to those of the above-described various embodiments, so the description is omitted. These coordinates can be referred to as first positions or second positions.

When the reference coordinate 1201 is moved from the virtual attraction coordinate 1212 to the virtual attraction coordinate 1211, the reference coordinate 1201 is influenced by the virtual attraction coordinate closer to the reference coordinate 1201. Then, in the process in which the reference coordinate 1201 approaches from the virtual attraction coordinate 1212 to the virtual attraction coordinate 1211, the magnitude of the influence reverses, and the operating force abruptly changes. In other words, where attraction at each virtual attraction coordinate is considered as a reference, a pseudo virtual repulsion potential field is set between the virtual attraction coordinates. When the reference coordinate 1201 passes through the position where the magnitude of the influence reverses, the force pulling to the virtual attraction coordinate 1212 changes into the force pulling to the virtual attraction coordinate 1211. In other words, the force pulling in the +θ-axis direction changes into the force pushing in the −θ-axis direction. Therefore, a user who is moving the hand part in the −θ-axis direction can feel an abrupt change in operating force to obtain a clicking sensation.

When the user feels the change in operating force, the user can grasp how many virtual attraction coordinates the reference coordinate 1201 has moved in the θ-axis direction and can grasp how much the link 202 has moved. The notification of the present embodiment is to notify how much the link 202 has moved, through a change in operating force in conjunction with the movement of the position of the reference coordinate 1201. Since a virtual attraction potential field is generated at each virtual attraction coordinate, even when the user releases his or her hand from the robot arm body 200, the link 202 is positioned at the virtual attraction coordinate. Therefore, it is possible to reduce the unnecessarily excessive movement of the link 202 although the user does not intend to move the hand, so it is preferable.

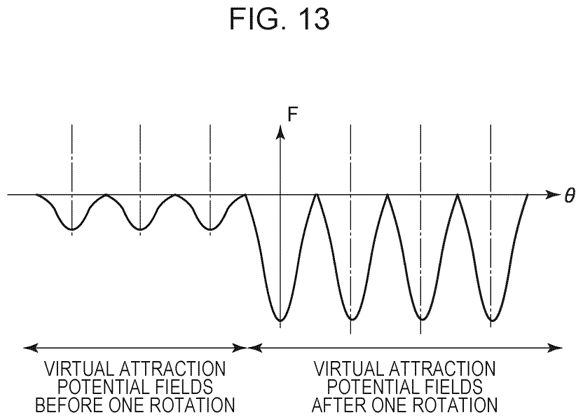

In FIG. 12, the virtual attraction potential field 1224 and the virtual attraction potential field (not shown) set at the virtual attraction coordinate 1208 are set so as to be larger than the other virtual attraction potential fields. Thus, it is possible to make the user strongly perceive a clicking sensation for each of a predetermined number of virtual attraction coordinates, and to make the user perceive the passage of the predetermined number of virtual attraction coordinates. In the present embodiment, a strong clicking sensation is provided at the position that is half the rotation range of the joint J2, and it is possible for the user to intuitively grasp half rotation of the joint J2, so it is preferable. Therefore, it is possible to reduce the likelihood that the user erroneously counts the number of virtual attraction coordinates passed.

Where the joint J2 is rotatable by 360 degrees or more, when the joint J2 has been moved in the +θ direction from the state of FIG. 12 and positioned at the virtual attraction coordinate 1202, the virtual attraction potential fields 1221 to 1124 may be used again. As shown in FIG. 13, when the joint J2 is rotatable by 360 degrees or more, the virtual attraction potential fields after one rotation (after 360-degree rotation) are increased compared to the virtual attraction potential fields before one rotation (before 360-degree rotation). Thus, a user is able to easily grasp one rotation through the strong clicking sensation, so it is preferable. Therefore, it is possible to reduce the likelihood that the user erroneously counts the number of rotations of the joint J2.

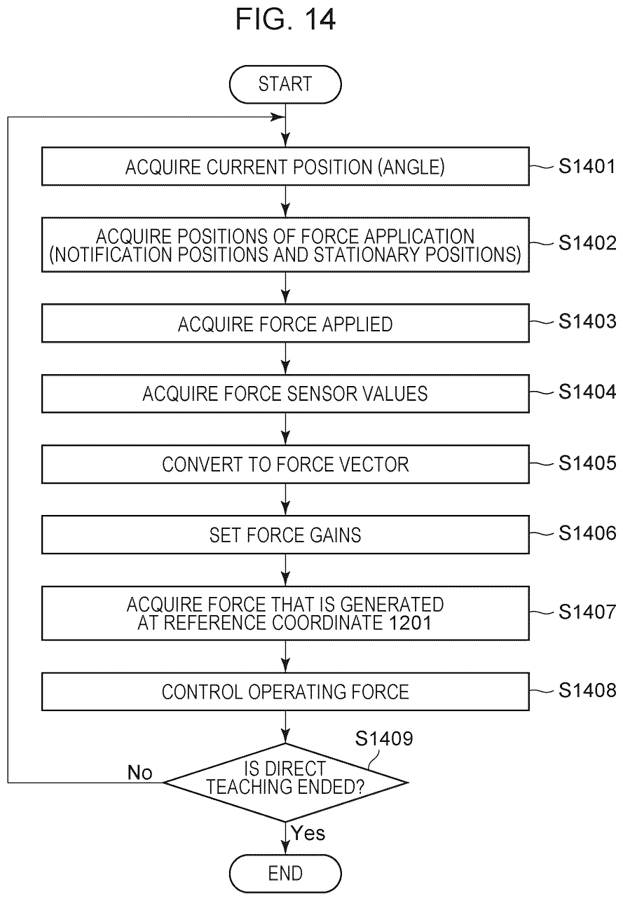

FIG. 14 is a control flowchart in the present embodiment. The control flowchart described with reference to FIG. 14 is executed through the coordination between the CPU 401 of the controller 400 and the CPU mounted at each joint. Here, the virtual attraction coordinates (angles) are defined as stationary positions, and the positions (angles) where the magnitude of influence reverses are defined as notification positions. As a premise, it is assumed that virtual coordinates, virtual repulsion fields, virtual attraction fields, stationary positions, and notification positions are set in control of the robot system 1000.

From FIG. 14, initially, in step S1401, the sensor value is acquired from the encoder (not shown) provided in the motor 212, to acquire the current position of the reference coordinate 1201 (rotation angle of the joint J2), thus acquiring the current position of the reference coordinate 1201. In the present embodiment, the position of the link 202 is acquired with the motor encoder. Alternatively, an output shaft ENC that directly detects the position of the link 202 may be used, or the predetermined position of the link 202 may be directly detected by using an image capturing apparatus or the like.

Subsequently, in step S1402, the positions (angles) where a force is applied to the reference coordinate 1201 are acquired based on the current position acquired in step S1401 and the notification positions and stationary positions set in advance. In the present embodiment, information about virtual coordinates, notification positions, stationary positions, and virtual repulsion and attraction information on virtual repulsion and attraction set at those positions is stored in a simulator storing the robot system 1000 as a model. Then, the information about the positions where a force is applied to the reference coordinate 1201 (the notification positions and the stationary positions) is acquired from the simulator. In the present embodiment, a simulator is used. Alternatively, various formats of data storing information about virtual coordinates, notification positions, stationary positions, and virtual planned repulsion and attraction set at those positions may be used.

Subsequently, in step S1403, the force that is currently applied to the reference coordinate 1201 is acquired based on the current position of the reference coordinate 1201 and the information about the notification positions and the stationary positions. Subsequently, in step S1404, the force applied by the user to the link 202 is acquired from the value of the force sensor 252.

Subsequently, in step S1405, the force in the θ-axis direction at the reference coordinate 1201 is acquired from the value of the force sensor 252. In the present embodiment, the force in the θ-axis direction at the predetermined position of the link 202 is acquired based on the value of the force sensor 252 and the link parameters of the link 202. Then, the force in the θ-axis direction at the predetermined position of the link 202 is acquired as the force in the θ-axis direction at the reference coordinate 1201.

In the subsequent step S1406, gains of the forces in directions other than a specific axis direction are set to zero such that the reference coordinate 1201 operates in the specific axis direction. In the present embodiment, the link 202 is controlled to move in the θ-axis direction at the reference coordinate 1201.

In the subsequent step S1407, the force generated at the reference coordinate 1201 is acquired based on the forces that are applied to the reference coordinate 1201 from the virtual repulsion potential fields and/or virtual attraction potential fields set at the notification positions and the stationary positions, and the force applied from the user.

Then, in step S1408, the damping coefficient D and the spring coefficient K are changed using the force generated at the reference coordinate 1201 and acquired in step S1407 as input, and the operating force needed to operate the link 202 is controlled. Thus, it is possible to notify the user of a clicking sensation due to virtual attraction and/or virtual repulsion through a change in the operating force.

Then, in step S1409, it is determined whether the user has provided instructions to end direct teaching. When the user has not provided instructions to end direct teaching, the determination in step S1409 is negative, the process returns to step S1401, and the above-described control flowchart is repeated. When the user has provided instructions to end direct teaching, the determination in step S1409 is affirmative, and the control flowchart ends.

According to the above-described present embodiment, the position (angle) of the link 202 is notified to the user by changing the operating force needed when the user directly operates the robot. Thus, the user is able to operate the robot while grasping the coordinate during operation (while grasping how much the robot arm body 200 or the robot hand body 300 has moved). Thus, for example, it is possible to make the user intuitively grasp the position of the robot while the user is performing direct teaching, with the result that it is possible to improve the operability of robot operation by the user.

In the present embodiment, the description is made by way of an example of the joint J2; however, the configuration is not limited thereto. For example, the operation may be performed at the joints J1, J3, J4, J5, J6. The control in the present embodiment may be executed for all the joints, or the control in the present embodiment may be executed at some of the joints. The above-described various embodiments and modifications may be implemented in combination with the present embodiment and/or the present modification.

### Sixth Embodiment

Next, the sixth embodiment will be described in detail. In the sixth embodiment, a light 260 is illuminated as a display device (indicator) provided on the robot arm body 200 during the execution of direct teaching, to notify how much the hand part of the robot arm body 200 has moved. In the present embodiment, a light is used; however, an apparatus that emits light as needed, such as a beacon light, may be used. In teaching of a robot, coordinates, such as a robot coordinate system, a tool coordinate system, and a user coordinate system, are provided according to the application; however, any coordinate system is applicable, and another coordinate for this teaching may be provided. In the present embodiment, the case where the reference coordinate 3001 is moved in the coordinate system of the entire robot system 1000 will be described as an example. In the following description, the portions of the configuration of the hardware and control system, different from those of the above-described various embodiments, will be described with reference to the drawings. Similar portions to those of the above-described various embodiments have the same configuration and function as described above, and the detailed description thereof is omitted.

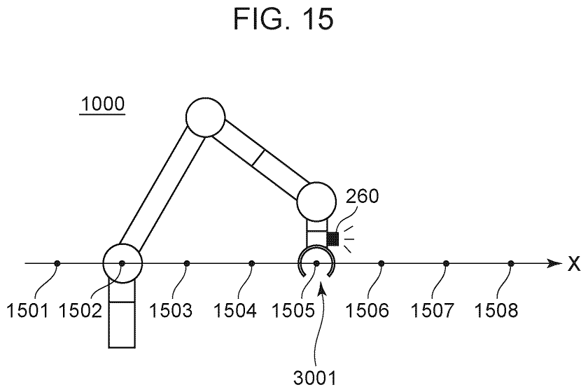

FIG. 15 is a diagram in which virtual coordinates in the X-axis direction, set in the present embodiment, are set at equal intervals. In the present embodiment, for the sake of convenience of description, the movement of the hand part of the robot arm body 200 is defined in the X-axis direction; however, the movement may be defined in a plurality of axes (two axes or three axes) as in the case of the second embodiment or may be defined in the rotation axis as in the case of the fifth embodiment.

As shown in FIG. 15, virtual coordinates 1501 to 1508 are set in the X-axis direction, and the light 260 illuminates when the reference coordinate 3001 is positioned at or passes through any one of the virtual coordinates. Then, in the state of FIG. 15, the reference coordinate 3001 is positioned at the virtual coordinate 1505. From this state, when the reference coordinate 3001 is moved from the virtual coordinate 1505 to the virtual coordinate 1506, the light 260 is illuminated at the timing when the reference coordinate 3001 is positioned at the virtual coordinate 1506. These coordinates can be referred to as first positions or second positions.

Thus, when the user feels the blinking of the light 260, the user can grasp how many virtual coordinates the reference coordinate 3001 has moved and can grasp how much the robot arm body 200 has moved. The notification of the present embodiment is to notify how much the robot arm body 200 has moved, through blinking of light in conjunction with the movement of the position of the reference coordinate 3001. These coordinates can be referred to as first positions or second positions.

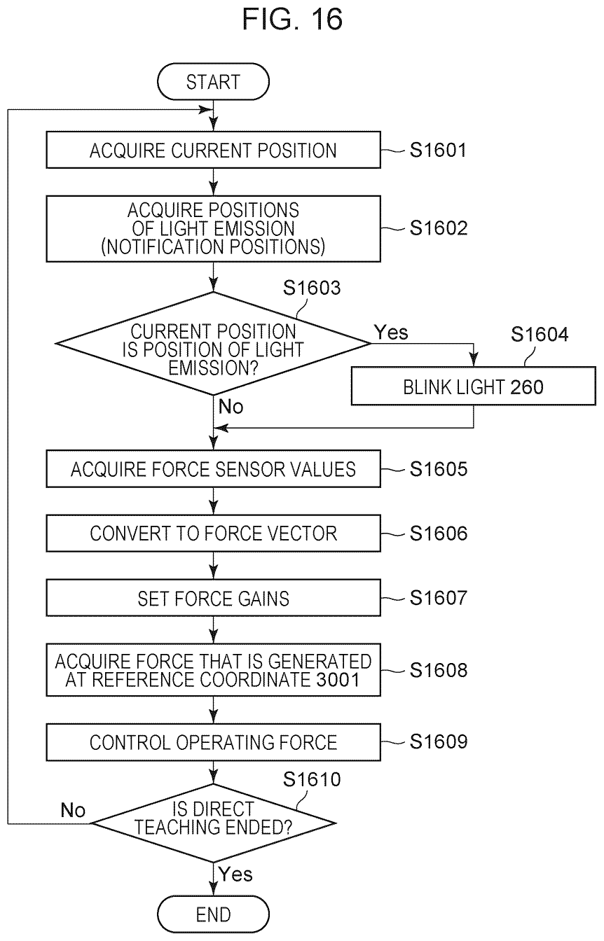

FIG. 16 is a control flowchart in the present embodiment. The control flowchart described with reference to FIG. 16 is executed through the coordination between the CPU 401 of the controller 400 and the CPU mounted at each joint. Here, the virtual coordinates (the positions where the light 260 is blinked) are defined as notification positions. As a premise, it is assumed that virtual coordinates are set in control of the robot system 1000.

As shown in FIG. 16, initially, in step S1601, sensor values are acquired from the encoders (not shown) provided in the motors 211 to 216, to acquire the current position of the reference coordinate 3001. In the present embodiment, the positions of the links 201 to 205 are acquired by the motor encoders. Alternatively, the positions of the links 201 to 205 may be directly detected by using an output shaft ENC that directly detects the positions of the links 201 to 205 or the hand part of the robot arm body 200 may be directly detected by an image capturing apparatus or the like.

Subsequently in step S1602, the positions where light is emitted are acquired based on the current position acquired in step S1601 and the notification positions set in advance. In the present embodiment, virtual coordinates are stored in a simulator that stores the robot system 1000 as a model. Then, the information about the positions where light is emitted (the notification positions) is acquired from the simulator. In the present embodiment, a simulator is used. Alternatively, various formats of data storing virtual coordinates may be used.

Subsequently, in step S1603, it is determined whether the current position of the reference coordinate 3001 is the position where light is emitted. When the determination is affirmative in step S1603, the process proceeds to step S1604, and the light 260 is blinked. When the determination is negative in step S1603, the light 260 is not blinked, and the process proceeds to step S1605.

Subsequently, in step S1605, the force applied by the user to the hand part of the robot arm body 200 is acquired from the values of the force sensors 251 to 256. Subsequently, in step S1606, the forces in the respective axis directions (XYZ) at the reference coordinate 3001 are acquired based on the values of the force sensors 251 to 256. In the present embodiment, the forces in the respective axis directions (XYZ) at the predetermined position of the link 205 are acquired based on the values of the force sensors 251 to 256 and the link parameters of the robot arm body 200. Then, the forces in the respective axis directions (XYZ) at the predetermined position of the link 205 are acquired as the forces in the respective axis directions (XYZ) at the reference coordinate 3001. This is because the link 205 that is the distal end link as the hand part of the robot arm body 200 is easy for the user to perform direct teaching. Of course, when the robot hand body 300 is operated to perform direct teaching, the forces in the respective axis directions (XYZ) at a predetermined position in the robot hand body 300 may be acquired. In that case, the forces in the respective axis directions (XYZ) are acquired from the values of the force sensors 251 to 256, the link parameters of the robot arm body 200, and the shape parameters of the robot hand body 300.

In the subsequent step S1607, gains of the forces in directions other than a specific axis direction are set to zero such that the reference coordinate 3001 operates in the specific axis direction. In the present embodiment, the hand part of the robot arm body 200 is controlled to move in the X-axis direction at the reference coordinate 3001. Thus, in step S506, the gains of the forces in the Y direction and Z direction of the robot arm body 200 are set to zero in the XYZ coordinate system. In the present embodiment, the hand part of the robot arm body 200 is controlled to move in the X direction. Alternatively, the hand part of the robot arm body 200 may be moved in the Y direction or may be moved in the Z direction.

In the subsequent step S1608, the force generated at the reference coordinate 3001 is acquired based on the force applied from the user. Then, in step S1609, the damping coefficient D and the spring coefficient K are changed using the force generated at the reference coordinate 3001 and acquired in step S1608 as input, and the operating force needed to operate the hand part of the robot arm body 200 is controlled.

Then, in step S1610, it is determined whether the user has provided instructions to end direct teaching. When the user has not provided instructions to end direct teaching, the determination in step S1610 is negative, the process returns to step S1601, and the above-described control flowchart is repeated. When the user has provided instructions to end direct teaching, the determination in step S1610 is affirmative, and the control flowchart ends.

According to the above-described present embodiment, the position of the robot is notified to the user by emitting light when the user directly operates the robot. Thus, the user is able to operate the robot while grasping the coordinate during operation (while grasping how much the robot arm body 200 or the robot hand body 300 has moved). Thus, for example, it is possible to make the user intuitively grasp the position of the robot while the user is performing direct teaching, with the result that it is possible to improve the operability of robot operation by the user.

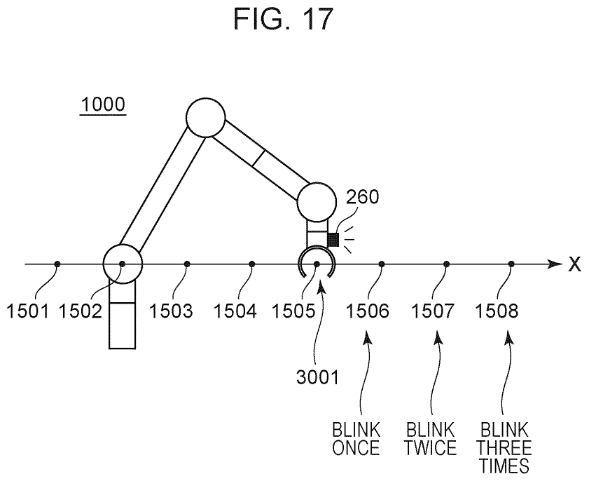

When the movement is being performed consecutively in the same direction on the same axis, the blinking cycle of the light 260 may be set so as to correspond to the number of virtual coordinates passed. For example, consider the case of moving the reference coordinate 3001 from the virtual coordinate 1505 to the virtual coordinate 1508, as shown in FIG. 17. In that case, from FIG. 17, when the reference coordinate is positioned at the virtual coordinate 1506, the light 260 is lit once in a second (blinking at a frequency of once per second). When the reference coordinate 3001 is positioned at the virtual coordinate 1507 further from that state, the light 260 is lit twice in a second (blinking at a frequency of twice per second) because the reference coordinate 3001 is consecutively moving in the same direction on the same axis. When the reference coordinate 3001 is positioned at the virtual coordinate 1508 further from that state, the light 260 is lit three times in a second (blinking at a frequency of three times per second) because the reference coordinate 3001 is consecutively moving in the same direction on the same axis. In the present embodiment, the cycle is set to one second; however, a selected cycle may be set. Then, when the movement has not been detected for a predetermined time, the number of times of blinking is reset.

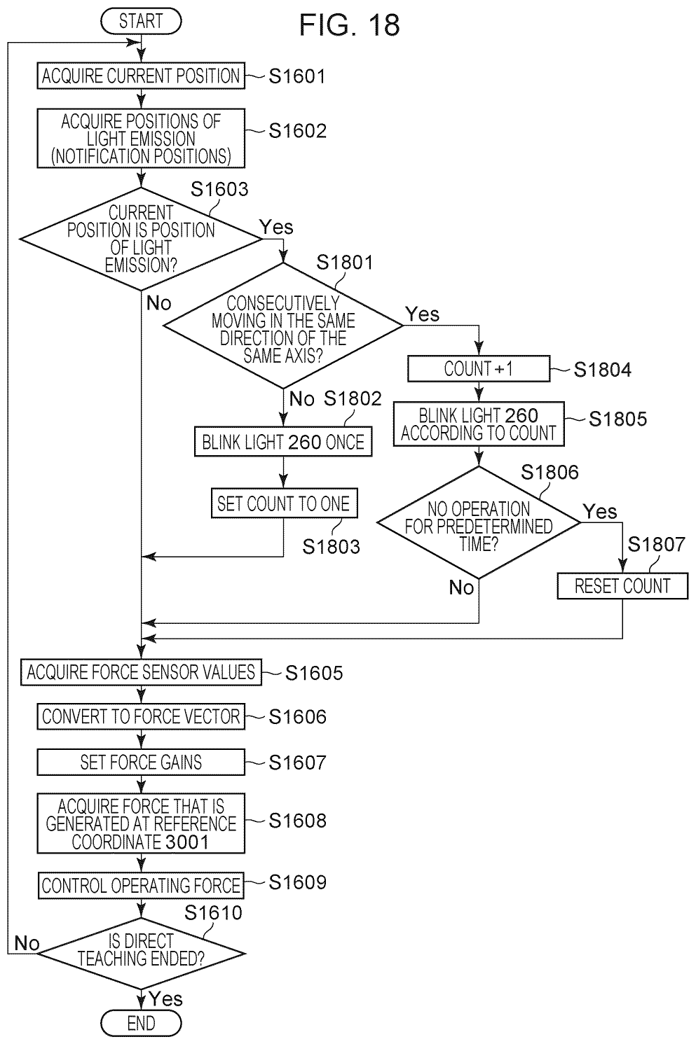

FIG. 18 is a control flowchart when the light 260 shown in FIG. 17 is blinked multiple times. The control flowchart described with reference to FIG. 18 is executed through the coordination between the CPU 401 of the controller 400 and the CPU mounted at each joint. The control flowchart described with reference to FIG. 18 includes the process of step S1801 to step 1807 in addition to the control flowchart shown in FIG. 16.

Initially, in step S1801, it is determined whether the reference coordinate 3001 is consecutively moving among the positions where light is emitted in the same direction on the same axis. When the determination is negative in step S1801, the process proceeds to step S1802, and the light 260 is blinked once as described above. Then, in step S1803, the number of a counter that counts the virtual coordinates that the reference coordinate 3001 has passed through is set to one. By setting the count to one, the count can always be set to one when the direction of operation (+ direction or − direction, or the X-axis direction, the Y-axis direction, or the Z-axis direction) changes.

When the determination is affirmative in step S1801, the process proceeds to step S1804, and the counter that counts the virtual coordinates that the reference coordinate 3001 has passed through is incremented by one. This is because the reference coordinate 3001 has passed through the virtual coordinates at least twice since the reference coordinate 3001 is “consecutively” moving according to the determination of step S1801. Then, in step S1805, the light 260 is blinked as described above according to the count.

Then, in step S1806, it is determined whether there is any operation within a predetermined time. When an operation is received from the user within the predetermined time, the process proceeds to step S1605. When there is no operation from the user within the predetermined time, the count is reset in step S1807. Thus, since the virtual coordinates are counted while the user is operating the robot, it is possible for the user to intuitively grasp how much the robot has moved since the start of the operation while the user is operating the robot.

Step S1806 and step S1807 may be omitted. In that case, it is possible for the user to intuitively grasp the amount of movement from when the direction of operation is changed. When the control flowchart ends, the counter is reset.

Thus, it is possible for the user to further intuitively grasp how much the hand part of the robot arm body 200 has been moved. The above-described various embodiments and modifications may be implemented in combination with the present embodiment and/or the present modification.

### Seventh Embodiment

Next, the seventh embodiment will be described in detail. In the seventh embodiment, a speaker 270 provided on the robot arm body 200 produces sound during the execution of direct teaching, to notify how much the hand part of the robot arm body 200 has moved. In the present embodiment, a speaker will be described as an example; however, any apparatus that produces sound as needed may be used. In teaching of a robot, coordinates, such as a robot coordinate system, a tool coordinate system, and a user coordinate system, are provided according to the application; however, any coordinate system is applicable, and another coordinate for this teaching may be provided. In the present embodiment, the case where the reference coordinate 3001 is moved in the coordinate system of the entire robot system 1000 will be described as an example. In the following description, the portions of the configuration of the hardware and control system, different from those of the above-described various embodiments, will be described with reference to the drawings. Similar portions to those of the above-described various embodiments have the same configuration and function as described above, and the detailed description thereof is omitted.

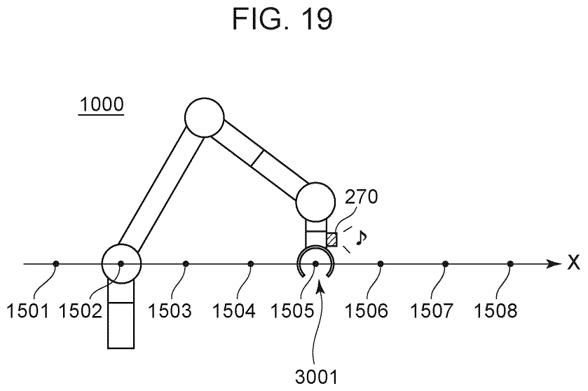

FIG. 19 is a diagram in which virtual coordinates in the X-axis direction, set in the present embodiment, are set at equal intervals. In the present embodiment, for the sake of convenience of description, the movement of the hand part of the robot arm body 200 is defined in the X-axis direction; however, the movement may be defined in a plurality of axes (two axes or three axes) as in the case of the second embodiment or may be defined in the rotation axis as in the case of the fifth embodiment.

As shown in FIG. 19, virtual coordinates 1501 to 1508 are set in the X-axis direction, and the speaker 270 produces sound when the reference coordinate 3001 is positioned at or passes through any one of the virtual coordinates. Then, in the state of FIG. 19, the reference coordinate 3001 is positioned at the virtual coordinate 1505. From this state, when the reference coordinate 3001 is moved from the virtual coordinate 1505 to the virtual coordinate 1506, the speaker 270 produces a predetermined sound at the timing when the reference coordinate 3001 is positioned at the virtual coordinate 1506. These coordinates can be referred to as first positions or second positions.

Thus, when the user feels the sound from the speaker 270, the user can grasp how many virtual coordinates the reference coordinate 3001 has moved and can grasp how much the robot arm body 200 has moved. The notification of the present embodiment is to notify how much the robot arm body 200 has moved, through production of sound in conjunction with the movement of the position of the reference coordinate 3001.

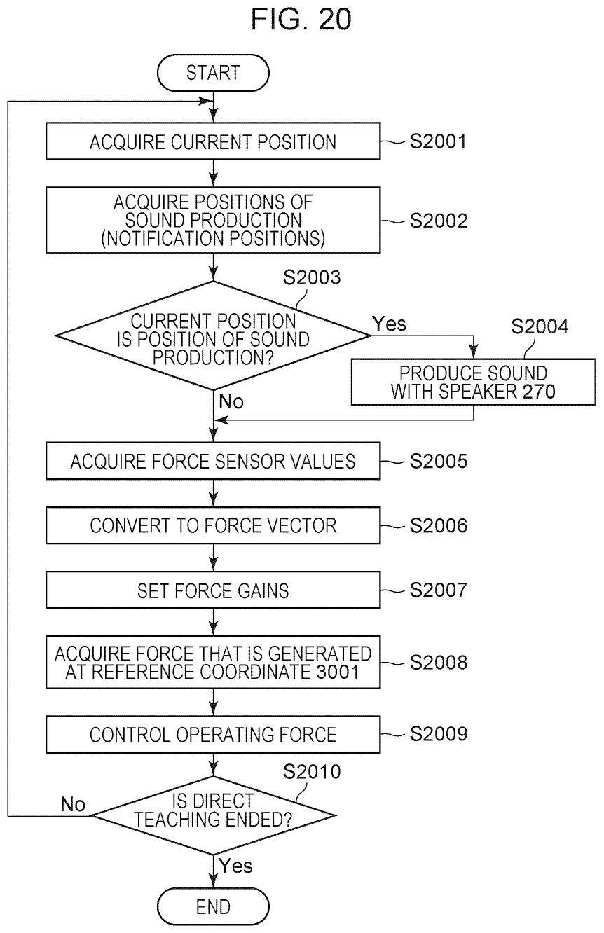

FIG. 20 is a control flowchart in the present embodiment. The control flowchart described with reference to FIG. 20 is executed through the coordination between the CPU 401 of the controller 400 and the CPU mounted at each joint. Here, the virtual coordinates (the positions where sound is produced from the speaker 270) are defined as notification positions. As a premise, it is assumed that virtual coordinates are set in control of the robot system 1000.

As shown in FIG. 20, initially, in step S2001, sensor values are acquired from the encoders (not shown) provided in the motors 211 to 216, to acquire the current position of the reference coordinate 3001. In the present embodiment, the positions of the links 201 to 205 are acquired by the motor encoders. Alternatively, the positions of the links 201 to 205 may be directly detected by using an output shaft ENC that directly detects the positions of the links 201 to 205 or the hand part of the robot arm body 200 may be directly detected by an image capturing apparatus or the like.

Subsequently in step S2002, the positions where sound is produced are acquired based on the current position acquired in step S2001 and the notification positions set in advance. In the present embodiment, virtual coordinates are stored in a simulator that stores the robot system 1000 as a model. Then, the information about the positions where sound is produced (the notification positions) is acquired from the simulator. In the present embodiment, a simulator is used. Alternatively, various formats of data storing virtual coordinates may be used.

Subsequently, in step S2003, it is determined whether the current position of the reference coordinate 3001 is the position where sound is produced. When the determination is affirmative in step S2003, the process proceeds to step S2004, and a predetermined sound is produced from the speaker 270. The type of sound may be any one of a chime, a buzzer, and a desired sound. When the determination is negative in step S2003, no sound is produced from the speaker 270, and the process proceeds to step S2005.

Subsequently, in step S2005, the force applied by the user to the hand part of the robot arm body 200 is acquired from the values of the force sensors 251 to 256. Subsequently, in step S2006, the forces in the respective axis directions (XYZ) at the reference coordinate 3001 are acquired based on the values of the force sensors 251 to 256. In the present embodiment, the forces in the respective axis directions (XYZ) at the predetermined position of the link 205 are acquired based on the values of the force sensors 251 to 256 and the link parameters of the robot arm body 200. Then, the forces in the respective axis directions (XYZ) at the predetermined position of the link 205 are acquired as the forces in the respective axis directions (XYZ) at the reference coordinate 3001. This is because the link 205 that is the distal end link as the hand part of the robot arm body 200 is easy for the user to perform direct teaching. Of course, when the robot hand body 300 is operated to perform direct teaching, the forces in the respective axis directions (XYZ) at a predetermined position in the robot hand body 300 may be acquired. In that case, the forces in the respective axis directions (XYZ) are acquired from the values of the force sensors 251 to 256, the link parameters of the robot arm body 200, and the shape parameters of the robot hand body 300.

In the subsequent step S2007, gains of the forces in directions other than a specific axis direction are set to zero such that the reference coordinate 3001 operates in the specific axis direction. In the present embodiment, the hand part of the robot arm body 200 is controlled to move in the X-axis direction at the reference coordinate 3001. Thus, in step S2006, the gains of the forces in the Y direction and Z direction of the robot arm body 200 are set to zero in the XYZ coordinate system. In the present embodiment, the hand part of the robot arm body 200 is controlled to move in the X direction. Alternatively, the hand part of the robot arm body 200 may be moved in the Y direction or may be moved in the Z direction.

In the subsequent step S2008, the force generated at the reference coordinate 3001 is acquired based on the force applied from the user. Then, in step S2009, the damping coefficient D and the spring coefficient K are changed using the force generated at the reference coordinate 3001 and acquired in step S2008 as input, and the operating force needed to operate the hand part of the robot arm body 200 is controlled.

Then, in step S2010, it is determined whether the user has provided instructions to end direct teaching. When the user has not provided instructions to end direct teaching, the determination in step S2010 is negative, the process returns to step S2001, and the above-described control flowchart is repeated. When the user has provided instructions to end direct teaching, the determination in step S2010 is affirmative, and the control flowchart ends.

According to the above-described present embodiment, the position of the robot is notified to the user by producing sound when the user directly operates the robot. Thus, the user is able to operate the robot while grasping the coordinate during operation (while grasping how much the robot arm body 200 or the robot hand body 300 has moved). Thus, for example, it is possible to make the user intuitively grasp the position of the robot while the user is performing direct teaching, with the result that it is possible to improve the operability of robot operation by the user.

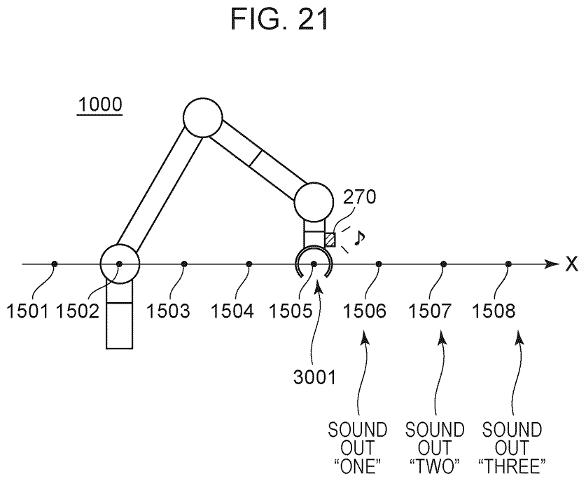

When the movement is being performed consecutively in the same direction on the same axis, sound produced from the speaker 270 may be set so as to correspond to the number of virtual coordinates passed. For example, consider the case of moving the reference coordinate 3001 from the virtual coordinate 1505 to the virtual coordinate 1508, as shown in FIG. 21. In that case, from FIG. 21, when the reference coordinate is positioned at the virtual coordinate 1506, the speaker 270 is caused to pronounce “one”. When the reference coordinate 3001 is positioned at the virtual coordinate 1507 further from that state, the speaker 270 is caused to pronounce “two” because the reference coordinate 3001 is consecutively moving in the same direction on the same axis. When the reference coordinate 3001 is positioned at the virtual coordinate 1508 further from that state, the speaker 270 is caused to pronounce “three” because the reference coordinate 3001 is consecutively moving in the same direction on the same axis. Then, when the movement has not been detected for a predetermined time, the number of times of count is reset.

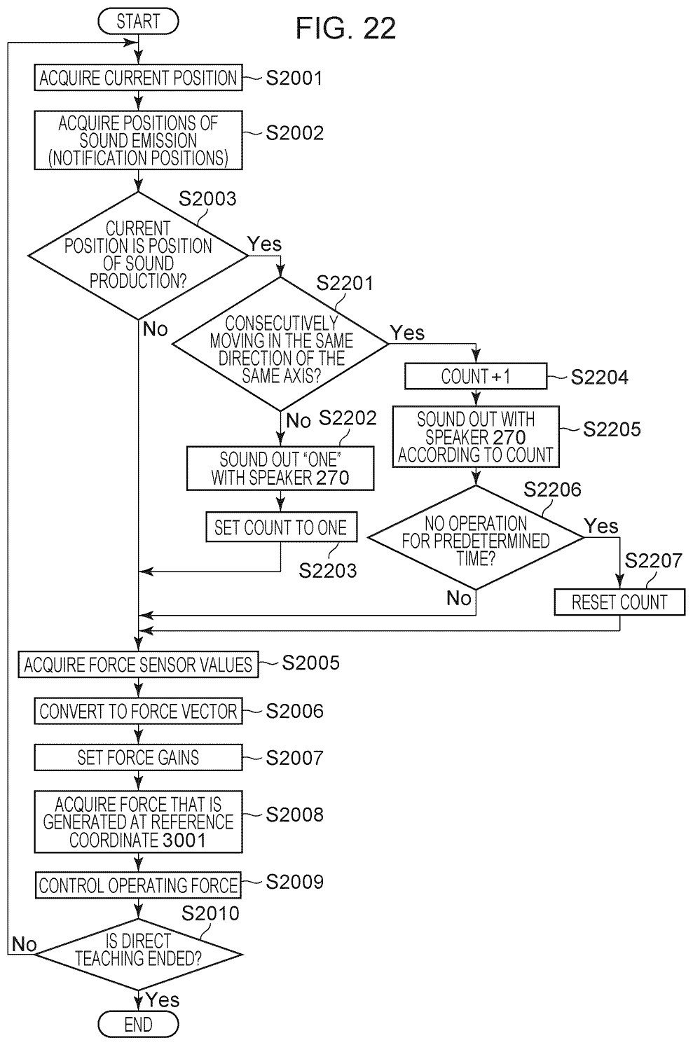

FIG. 22 is a control flowchart when the corresponding sound is produced by the speaker 270 shown in FIG. 21. The control flowchart described with reference to FIG. 22 is executed through the coordination between the CPU 401 of the controller 400 and the CPU mounted at each joint. The control flowchart described with reference to FIG. 22 includes the process of step S2201 to step 2207 in addition to the control flowchart shown in FIG. 20.

Initially, in step S2201, it is determined whether the reference coordinate 3001 is consecutively moving among the positions where sound is produced in the same direction on the same axis. When the determination is negative in step S2201, the process proceeds to step S2202, and the speaker 270 pronounces “one” as described above. Then, in step S2203, the number of a counter that counts the virtual coordinates that the reference coordinate 3001 has passed through is set to one. By setting the count to one, the count can always be set to one when the direction of operation (+ direction or − direction, or the X-axis direction, the Y-axis direction, or the Z-axis side) changes.

When the determination is affirmative in step S2201, the process proceeds to step S2204, and the counter that counts the virtual coordinates that the reference coordinate 3001 has passed through is incremented by one. This is because the reference coordinate 3001 has passed through the virtual coordinates at least twice since the reference coordinate 3001 is “consecutively” moving according to the determination of step S2201. Then, in step S2205, the speaker 270 is caused to pronounce a sound corresponding to the count as described above.

Then, in step S2206, it is determined whether there is any operation within a predetermined time. When an operation is received from the user within the predetermined time, the process proceeds to step S2005. When there is no operation from the user within the predetermined time, the process proceeds to step S2207, and the count is reset. Thus, since the virtual coordinates are counted while the user is operating the robot, it is possible for the user to intuitively grasp how much the robot has moved since the start of the operation while the user is operating the robot. Step S2206 and step S2207 may be omitted. In that case, it is possible for the user to intuitively grasp the amount of movement from when the direction of operation is changed. When the control flowchart ends, the counter is reset.

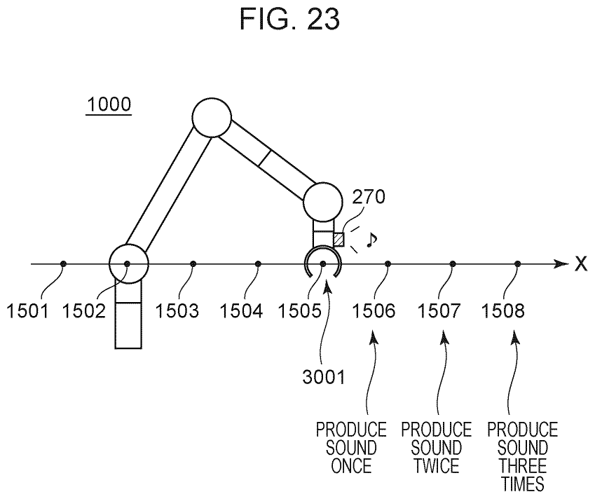

When the movement is being performed consecutively in the same direction on the same axis, sound from the speaker 270 may be consecutively produced so as to correspond to the number of virtual coordinates passed. For example, consider the case of moving the reference coordinate 3001 from the virtual coordinate 1505 to the virtual coordinate 1508, as shown in FIG. 23. In that case, from FIG. 23, when the reference coordinate is positioned at the virtual coordinate 1506, a buzzer sound is produced once in a second from the speaker 270 (producing a buzzer sound at a frequency of once per second). When the reference coordinate 3001 is positioned at the virtual coordinate 1507 further from that state, the speaker 270 is caused to produce a buzzer sound twice in a second (produce a buzzer sound at a frequency of twice per second) because the reference coordinate 3001 is consecutively moving in the same direction on the same axis. When the reference coordinate 3001 is positioned at the virtual coordinate 1508 further from that state, the speaker 270 is caused to produce a buzzer sound three times in a second (produce a buzzer sound at a frequency of three times per second) because the reference coordinate 3001 is consecutively moving in the same direction on the same axis. In the present embodiment, the cycle is set to one second; however, a selected cycle may be set. Then, when the movement has not been detected for a predetermined time, the number of times of blinking is reset.

Thus, it is possible for the user to further intuitively grasp how much the hand part of the robot arm body 200 has been moved. The above-described various embodiments and modifications may be implemented in combination with the present embodiment and/or the present modification. For example, by combining the present embodiment with the first to fifth embodiments in which notification is provided through a change in operating force as described above, a clicking sensation is generated at the notification position, and a clicking sound is also produced. Thus, it is possible to further clearly notify the user of the clicking sensation and the notification position, so it is also possible to improve an operating feel on the robot.

### Eighth Embodiment

Next, the eighth embodiment will be described in detail. In the eighth embodiment, numeric values are displayed on the display portion 280 serving as a display on the link 205 of the hand part of the robot arm body 200 during the execution of direct teaching, to notify how much the hand part of the robot arm body 200 has moved. In teaching of a robot, coordinates, such as a robot coordinate system, a tool coordinate system, and a user coordinate system, are provided according to the application; however, any coordinate system is applicable, and another coordinate for this teaching may be provided. In the present embodiment, the case where the reference coordinate 3001 is moved in the coordinate system of the entire robot system 1000 will be described as an example. In the following description, the portions of the configuration of the hardware and control system, different from those of the above-described various embodiments, will be described with reference to the drawings. Similar portions to those of the above-described various embodiments have the same configuration and function as described above, and the detailed description thereof is omitted.

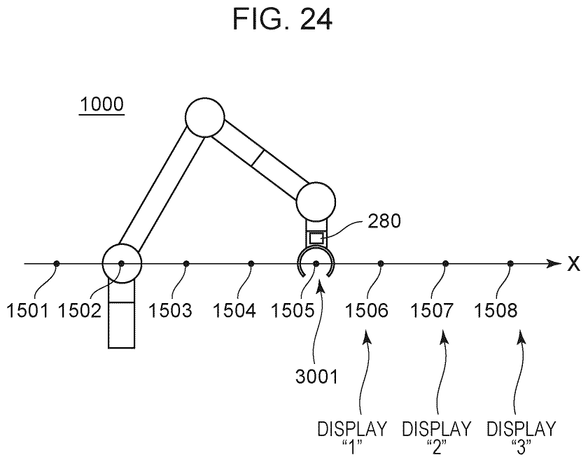

FIG. 24 is a diagram in which virtual coordinates in the X-axis direction, set in the present embodiment, are set at equal intervals. In the present embodiment, for the sake of convenience of description, the movement of the hand part of the robot arm body 200 is defined in the X-axis direction; however, the movement may be defined in a plurality of axes (two axes or three axes) as in the case of the second embodiment or may be defined in the rotation axis as in the case of the fifth embodiment.

As shown in FIG. 24, virtual coordinates 1501 to 1508 are set in the X-axis direction, and a corresponding numeric value is displayed on the display portion 280 when the reference coordinate 3001 is positioned at or passes through any one of the virtual coordinates. Then, in the state of FIG. 24, the reference coordinate 3001 is positioned at the virtual coordinate 1505. From this state, when the reference coordinate 3001 is moved from the virtual coordinate 1505 to the virtual coordinate 1506, the corresponding numeric value is displayed on the display portion 280 at the timing when the reference coordinate 3001 is positioned at the virtual coordinate 1506. These coordinates can be referred to as first positions or second positions.

In the present embodiment, when the movement is being performed consecutively in the same direction on the same axis, the numeric value to be displayed on the display portion 280 may be set so as to correspond to the number of virtual coordinates passed. Consider the case of moving the reference coordinate 3001 from the virtual coordinate 1505 to the virtual coordinate 1508, as shown in FIG. 24. In that case, from FIG. 24, when the reference coordinate is positioned at the virtual coordinate 1506, the display portion 280 is caused to display “one”. When the reference coordinate 3001 is positioned at the virtual coordinate 1507 further from that state, the display portion 280 is caused to display “two” because the reference coordinate 3001 is consecutively moving in the same direction on the same axis. When the reference coordinate 3001 is positioned at the virtual coordinate 1508 further from that state, the display portion 280 is caused to display “three” because the reference coordinate 3001 is consecutively moving in the same direction on the same axis. Then, when the movement has not been detected for a predetermined time, the number of times of count is reset.

Thus, when the user visually recognizes the display from the display portion 280, the user can grasp how many virtual coordinates the reference coordinate 3001 has moved and can grasp how much the robot arm body 200 has moved. The display portion 280 is provided at the hand part of the robot arm body 200, so visibility for the user improves. The notification of the present embodiment is to notify how much the robot arm body 200 has moved, through display of the numeric value in conjunction with the movement of the position of the reference coordinate 3001.

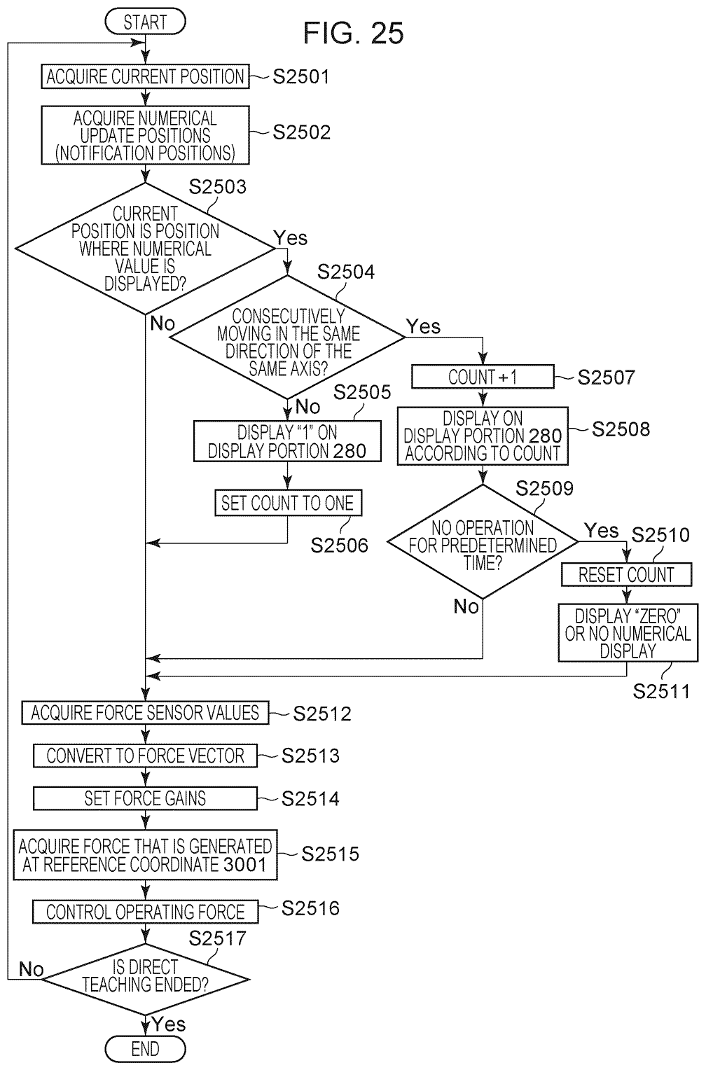

FIG. 25 is a control flowchart in the present embodiment. The control flowchart described with reference to FIG. 25 is executed through the coordination between the CPU 401 of the controller 400 and the CPU mounted at each joint. Here, the virtual coordinates (the positions where the numeric value is displayed on the display portion 280) are defined as notification positions. As a premise, it is assumed that virtual coordinates are set in control of the robot system 1000. As a premise, the initial display of the display portion 280 is set such that the display portion 280 displays a numeric value of “zero” or does not display a numeric value.

As shown in FIG. 25, initially, in step S2501, sensor values are acquired from the encoders (not shown) provided in the motors 211 to 216, to acquire the current position of the reference coordinate 3001. In the present embodiment, the positions of the links 201 to 205 are acquired by the motor encoders. Alternatively, the positions of the links 201 to 205 may be directly detected by using an output shaft ENC that directly detects the positions of the links 201 to 205 or the hand part of the robot arm body 200 may be directly detected by an image capturing apparatus or the like.

Subsequently, in step S2502, the positions where the numeric value is updated are acquired based on the current position acquired in step S2501 and the notification positions set in advance. In the present embodiment, virtual coordinates are stored in a simulator that stores the robot system 1000 as a model. Then, the information about the positions where the numeric value is updated (the notification positions) is acquired from the simulator. In the present embodiment, a simulator is used. Alternatively, various formats of data storing virtual coordinates may be used.

Subsequently, in step S2503, it is determined whether the current position of the reference coordinate 3001 is the position where the numeric value is updated. When the determination is affirmative in step S2503, the process proceeds to step S2504. When the determination is negative in step S2503, the display portion 280 does not update the display of the numeric value, and the process proceeds to step S2511.

Subsequently, in step S2504, it is determined whether the reference coordinate 3001 is moving among the positions where the display of the numeric value is updated in the same direction on the same axis. When the determination is negative in step S2504, the process proceeds to step S2505, and the display portion 280 shows “one” as described above. Then, in step S2506, the number of a counter that counts the virtual coordinates that the reference coordinate 3001 has passed through is set to one. By setting the count to one, the count can always be set to one when the direction of operation (+ direction or − direction, or the X-axis direction, the Y-axis direction, or the Z-axis side) changes.

When the determination is affirmative in step S2504, the process proceeds to step S2507, and the counter that counts the virtual coordinates that the reference coordinate 3001 has passed through is incremented by one. This is because the reference coordinate 3001 has passed through the virtual coordinates at least twice since the reference coordinate 3001 is “consecutively” moving according to the determination of step S2504. Then, in step S2508, the display portion 280 displays the numeric value corresponding to the count as described above.

Then, in step S2509, it is determined whether there is any operation within a predetermined time. When an operation is received from the user within the predetermined time, the process proceeds to step S2512. When there is no operation from the user within the predetermined time, the process proceeds to step S2510, the count is reset, and, in step S2511, the display portion 280 displays a numeric value of “zero” or does not display the numeric value. Thus, since the virtual coordinates are counted while the user is operating the robot, it is possible for the user to intuitively grasp how much the robot has moved since the start of the operation while the user is operating the robot. Step S2509 and step S2510 may be omitted. In that case, it is possible for the user to intuitively grasp the amount of movement from when the direction of operation is changed. When the control flowchart ends, the counter is reset.

Subsequently, in step S2512, the force applied by the user to the hand part of the robot arm body 200 is acquired from the values of the force sensors 251 to 256. Subsequently, in step S2513, the forces in the respective axis directions (XYZ) at the reference coordinate 3001 are acquired based on the values of the force sensors 251 to 256. In the present embodiment, the forces in the respective axis directions (XYZ) at the predetermined position of the link 205 are acquired based on the values of the force sensors 251 to 256 and the link parameters of the robot arm body 200. Then, the forces in the respective axis directions (XYZ) at the predetermined position of the link 205 are acquired as the forces in the respective axis directions (XYZ) at the reference coordinate 3001. This is because the link 205 that is the distal end link as the hand part of the robot arm body 200 is easy for the user to perform direct teaching. Of course, when the robot hand body 300 is operated to perform direct teaching, the forces in the respective axis directions (XYZ) at a predetermined position in the robot hand body 300 may be acquired. In that case, the forces in the respective axis directions (XYZ) are acquired from the values of the force sensors 251 to 256, the link parameters of the robot arm body 200, and the shape parameters of the robot hand body 300.

In the subsequent step S2514, gains of the forces in directions other than a specific axis direction are set to zero such that the reference coordinate 3001 operates in the specific axis direction. In the present embodiment, the hand part of the robot arm body 200 is controlled to move in the X-axis direction at the reference coordinate 3001. Thus, in step S2514, the gains of the forces in the Y direction and Z direction of the robot arm body 200 are set to zero in the XYZ coordinate system. In the present embodiment, the hand part of the robot arm body 200 is controlled to move in the X direction. Alternatively, the hand part of the robot arm body 200 may be moved in the Y direction or may be moved in the Z direction.

In the subsequent step S2515, the force generated at the reference coordinate 3001 is acquired based on the force applied from the user. Then, in step S2516, the damping coefficient D and the spring coefficient K are changed using the force generated at the reference coordinate 3001 and acquired in step S2515 as input, and the operating force needed to operate the hand part of the robot arm body 200 is controlled.

Then, in step S2517, it is determined whether the user has provided instructions to end direct teaching. When the user has not provided instructions to end direct teaching, the determination in step S2517 is negative, the process returns to step S2501, and the above-described control flowchart is repeated. When the user has provided instructions to end direct teaching, the determination in step S2517 is affirmative, and the control flowchart ends.

According to the above-described present embodiment, the position of the robot is notified to the user by displaying a numeric value when the user directly operates the robot. The numeric value is displayed at the hand part of the robot arm body 200. Thus, the user is able to operate the robot while grasping the coordinate during operation (while grasping how much the robot arm body 200 or the robot hand body 300 has moved). Thus, for example, it is possible to make the user intuitively grasp the position of the robot while the user is performing direct teaching, with the result that it is possible to improve the operability of robot operation by the user. The above-described various embodiments and modifications may be implemented in combination with the present embodiment and/or the present modification.

### Ninth Embodiment

Next, the ninth embodiment will be described in detail. In the ninth embodiment, the user interface for setting the conditions of the case where the above-described various embodiments are implemented will be described. In the following description, the portions of the configuration of the hardware and control system, different from those of the above-described various embodiments, will be described with reference to the drawings. Similar portions to those of the above-described various embodiments have the same configuration and function as described above, and the detailed description thereof is omitted. The robot system 1000 of the present embodiment is configured such that the above-described various embodiments can be implemented.

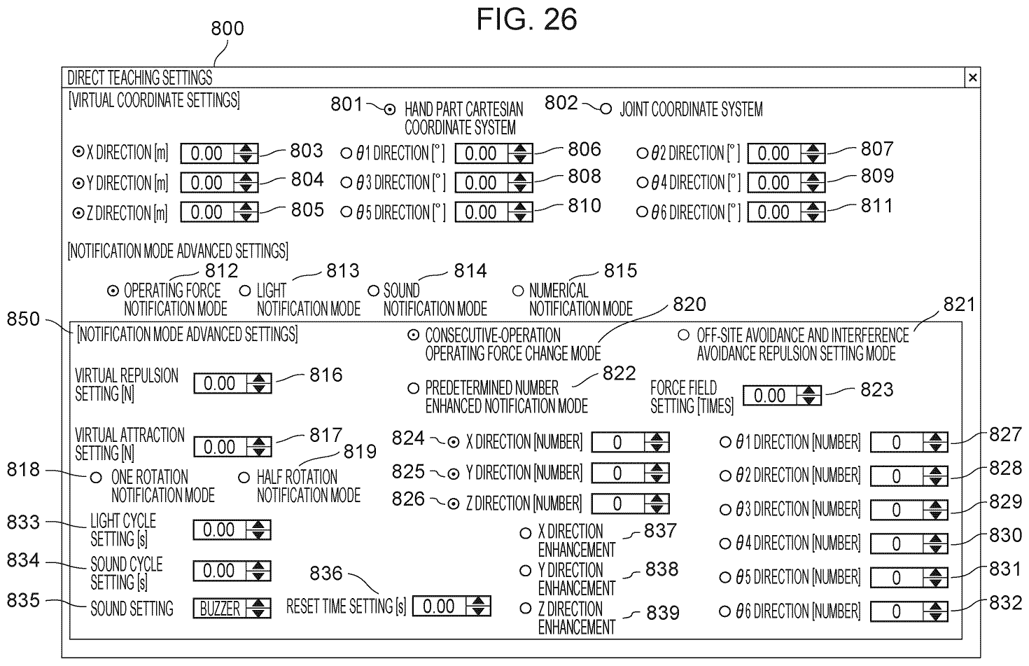

FIG. 26 shows a direct teaching settings screen 800 according to the present embodiment. When the direct teaching settings screen 800 is displayed in a touch panel format on the display portion 280 provided at the hand part of the robot arm body 200, the direct teaching settings screen 800 allows the user to easily change settings during direct teaching, so it is suitable. The direct teaching settings screen 800 may be displayed on the external input device 500, or may be displayed on a desktop PC, a laptop PC, a tablet PC, a smartphone, and the like, that are general-purpose computers capable of performing information processing.

From FIG. 26, initially, a hand part Cartesian coordinate system button 801 (radio button) and a joint coordinate system button 802 (radio button), with which it is possible to set or select virtual coordinates in which coordinate system, are shown on the direct teaching settings screen 800. In the example of FIG. 26, the hand part Cartesian coordinate system button 801 is selected. When the hand part Cartesian coordinate system button 801 (radio button) is selected, input of position interval input boxes 803, 804, 805 (described later) becomes active, and the radio buttons of the corresponding axes are in a selected state. When the joint coordinate system button 802 is selected, input of position interval input boxes 806, 807, 808, 809, 810, 811 (described later) becomes active, and the radio buttons of the corresponding axes are in a selected state. When both the hand part Cartesian coordinate system button 801 and the joint coordinate system button 802 are selected, input of all the position interval input boxes becomes active, and the radio buttons of the corresponding axes are in a selected state.

The position interval input box 803 allows to input the interval at which virtual coordinates are set in the X-axis direction in which the reference coordinate set at the hand part of the robot arm body 200 moves. By selecting the radio button on the sheet left side of the position interval input box 803, movement in the X-axis direction is allowed. When the radio button is deselected, movement in the X-axis direction is disabled. The position interval input box 804 allows to input the interval at which virtual coordinates are set in the Y-axis direction in which the reference coordinate set at the hand part of the robot arm body 200 moves. By selecting the radio button on the sheet left side of the position interval input box 804, movement in the Y-axis direction is allowed. When the radio button is deselected, movement in the Y-axis direction is disabled. The position interval input box 805 allows to input the interval at which virtual coordinates are set in the Z-axis direction in which the reference coordinate set at the hand part of the robot arm body 200 moves. By selecting the radio button on the sheet left side of the position interval input box 805, movement in the Z-axis direction is allowed. When the radio button is deselected, movement in the Z-axis direction is disabled.

The position interval input box 806 allows to input the interval at which the virtual coordinates are set in the θ-axis direction (rotation direction) in which the reference coordinate set at the joint J1 moves. By selecting the radio button on the sheet left side of the position interval input box 806, movement in the θ-axis direction (rotation direction) of the joint J1 is allowed. The position interval input box 807 allows to input the interval at which the virtual coordinates are set in the θ-axis direction (rotation direction) in which the reference coordinate set at the joint J2 moves. By selecting the radio button on the sheet left side of the position interval input box 807, movement in the θ-axis direction (rotation direction) of the joint J2 is allowed. The position interval input box 808 allows to input the interval at which the virtual coordinates are set in the θ-axis direction (rotation direction) in which the reference coordinate set at the joint J3 moves. By selecting the radio button on the sheet left side of the position interval input box 808, movement in the θ-axis direction (rotation direction) of the joint J3 is allowed.

The position interval input box 809 allows to input the interval at which the virtual coordinates are set in the θ-axis direction (rotation direction) in which the reference coordinate set at the joint J4 moves. By selecting the radio button on the sheet left side of the position interval input box 809, movement in the θ-axis direction (rotation direction) of the joint J4 is allowed. The position interval input box 810 allows to input the interval at which the virtual coordinates are set in the θ-axis direction (rotation direction) in which the reference coordinate set at the joint J5 moves. By selecting the radio button on the sheet left side of the position interval input box 810, movement in the θ-axis direction (rotation direction) of the joint J5 is allowed. The position interval input box 811 allows to input the interval at which the virtual coordinates are set in the θ-axis direction (rotation direction) in which the reference coordinate set at the joint J6 moves. By selecting the radio button on the sheet left side of the position interval input box 811, movement in the θ-axis direction (rotation direction) of the joint J6 is allowed.

By inputting numeric values to the position interval input boxes 803 to 805, virtual coordinates can be set at intervals in meters. In the present embodiment, the setting is in meters. Alternatively, the setting may be in millimeters or centimeters. By inputting numeric values to the position interval input boxes 806 to 811, virtual coordinates can be set at intervals in degrees (°). In the present embodiment, the setting is in degrees (°). Alternatively, the setting may be in radians. A numeric value may be input to the position interval input boxes 803 to 811 by directly inputting a displayed value with a keyboard and a mouse or setting a value with the up-down arrow buttons of each of the position interval boxes 803 to 811 using the mouse or touch.

From FIG. 26, the direct teaching settings screen 800 shows buttons for setting a mode in which the amount of movement of the robot arm body 200 is notified to the user. Control to provide notification through a change in operating force as described in the first to fifth embodiments is executed with an operating force notification mode button 812 (radio button). Control to provide notification through emitting light as described in the sixth embodiment is executed with a light notification mode button 813 (radio button). Control to provide notification through producing sound as described in the seventh embodiment is executed with a sound notification mode button 814 (radio button). Control to provide notification through updating the display of a numeric value as described in the eighth embodiment is executed with a numerical notification mode button 815 (radio button). All selected modes may be configured to be executed, or only one mode may be configured to be selected, or only two or three modes may be configured to be selected.

Subsequently, the direct teaching settings screen 800 shows the notification mode advanced settings screen 850 for advanced settings in the selected notification mode. The virtual repulsion setting input box 816 allows to set the maximum value in newtons of the virtual repulsion potential field uniformly set at each of the set virtual coordinates. A virtual repulsion range and a virtual repulsion potential distribution are set according to the input. The virtual attraction setting input box 817 allows to set the maximum value in newtons of the virtual attraction potential field uniformly set at each of the set virtual coordinates. A virtual attraction range and a virtual attraction potential distribution are set according to the input. It is assumed that one of the values is controlled to be zero. For example, when a value is input to the virtual repulsion setting input box 816, the virtual attraction setting input box 817 automatically becomes zero; whereas, when a value is input to the virtual attraction setting input box 817, the virtual repulsion setting input box 816 automatically becomes zero. A numeric value may be input to the virtual repulsion setting input box 816 and the virtual attraction setting input box 817 by directly inputting a displayed value with a keyboard and a mouse or setting a value with the up-down arrow buttons of each input box using the mouse or touch. In the present embodiment, the setting is in newtons. Alternatively, the setting in kgf may be implemented.

A one rotation notification mode button 818 (radio button) is a button for notifying the user of one rotation when multiple rotations (360° or more) are possible at the predetermined joint of the robot arm body 200, as described with reference to the fifth embodiment. When the one rotation notification mode button 818 is selected, the virtual repulsion potential field or attraction potential field after one rotation is increased compared to that before the one rotation. In the present embodiment, when the one rotation notification mode button 818 is selected, the value input to the virtual repulsion setting input box 816 or the virtual attraction setting input box 817 is automatically set to 200% of the input value. However, an input box may be prepared as needed to allow input of a value to be increased or a multiplication factor from the value input to the virtual repulsion setting input box 816 or the virtual attraction setting input box 817 may be configured to be set.

A half rotation notification mode button 819 (radio button) is a button for notifying the user of a rotation up to half of the range (half rotation) in the rotation range of the predetermined joint of the robot arm body 200 as described in the fifth embodiment. When the half rotation notification mode button 819 is selected, the repulsion potential field or attraction potential field of a virtual coordinate positioned halfway in the rotation range of the predetermined joint of the robot arm body 200 or near the position is increased. In the present embodiment, when the half rotation notification mode button 819 is selected, the value input to the virtual repulsion setting input box 816 or the virtual attraction setting input box 817 is automatically set to 200% of the input value. However, an input box may be prepared as needed to allow input of a value to be increased or a multiplication factor from the value input to the virtual repulsion setting input box 816 or the virtual attraction setting input box 817 may be configured to be set.

A consecutive-operation operating force change mode button 820 (radio button) is a button of a mode for changing the potential distribution of the force fields of the axis when movement is consecutive in the same axis direction, as described in the fourth embodiment. In the present embodiment, when the consecutive-operation operating force change mode button 820 is selected, the value input to the virtual repulsion setting input box 816 or the virtual attraction setting input box 817 is automatically set to 50% of the input value. However, an input box may be prepared as needed to allow input of a value to be set after change or a reduction factor from the value input to the virtual repulsion setting input box 816 or the virtual attraction setting input box 817 may be configured to be set.

An off-site avoidance and interference avoidance repulsion setting mode button 821 is a button of a mode in which repulsion potential fields are automatically set at predetermined virtual coordinate positions such that the hand part of the robot arm body 200 is not placed off the site or does not interfere with surrounding objects as described in the first embodiment. Whether the hand part of the robot arm body 200 is off the site and avoidance of interference with surrounding objects are determined by using a robot model set in advance by a robot simulator, and repulsion potential fields are automatically set at predetermined virtual coordinate positions.

A predetermined number enhanced notification mode button 822 is a button of a mode in which the virtual attraction potential field or virtual repulsion potential field is enhanced every predetermined number of virtual coordinates as described in the above embodiments. A force field setting input box 823 allows to set how many times to multiply the force field, at which enhanced notification is performed, by the value input to the virtual repulsion setting input box 816 or the virtual attraction setting input box 817. A numeric value may be input to the force field setting input box 823 by directly inputting a displayed value with a keyboard and a mouse or setting a value with the up-down arrow buttons of the input box using the mouse or touch. In the present embodiment, the multiplication factor is set. Alternatively, a percentage (%) may be set.

A number input box 824 allows to input the interval at which the repulsion potential field or attraction potential field is enhanced at virtual coordinates in the X-axis direction in which the reference coordinate set at the hand part of the robot arm body 200 moves. When the radio button on the sheet left side of the number input box 824 is selected, the enhanced notification mode is set in the X-axis direction. When the radio button is deselected, the enhanced notification mode is not set in the X-axis direction. A number input box 825 allows to input the interval at which the repulsion potential field or attraction potential field is enhanced at virtual coordinates in the Y-axis direction in which the reference coordinate set at the hand part of the robot arm body 200 moves. When the radio button on the sheet left side of the number input box 825 is selected, the enhanced notification mode is set in the Y-axis direction. When the radio button is deselected, the enhanced notification mode is not set in the Y-axis direction. A number input box 826 allows to input the interval at which the repulsion potential field or attraction potential field is enhanced at virtual coordinates in the Z-axis direction in which the reference coordinate set at the hand part of the robot arm body 200 moves. When the radio button on the sheet left side of the number input box 826 is selected, the enhanced notification mode is set in the Z-axis direction. When the radio button is deselected, the enhanced notification mode is not set in the Z-axis direction.

A number input box 827 allows to input the interval at which the repulsion potential field or attraction potential field is enhanced at virtual coordinates in the θ-axis direction (rotation direction) in which the reference coordinate set at the joint J1 moves. When the radio button on the sheet left side of the number input box 827 is selected, the enhanced notification mode is set in the θ-axis direction (rotation direction) of the joint J1. When the radio button is deselected, the enhanced notification mode is not set in the θ-axis direction (rotation direction) of the joint J1. A number input box 828 allows to input the interval at which the repulsion potential field or attraction potential field is enhanced at virtual coordinates in the θ-axis direction (rotation direction) in which the reference coordinate set at the joint J2 moves. When the radio button on the sheet left side of the number input box 828 is selected, the enhanced notification mode is set in the θ-axis direction (rotation direction) of the joint J2. When the radio button is deselected, the enhanced notification mode is not set in the θ-axis direction (rotation direction) of the joint J2. A number input box 829 allows to input the interval at which the repulsion potential field or attraction potential field is enhanced at virtual coordinates in the θ-axis direction (rotation direction) in which the reference coordinate set at the joint J3 moves. When the radio button on the sheet left side of the number input box 829 is selected, the enhanced notification mode is set in the θ-axis direction (rotation direction) of the joint J3. When the radio button is deselected, the enhanced notification mode is not set in the θ-axis direction (rotation direction) of the joint J3.

A number input box 830 allows to input the interval at which the repulsion potential field or attraction potential field is enhanced at virtual coordinates in the θ-axis direction (rotation direction) in which the reference coordinate set at the joint J4 moves. When the radio button on the sheet left side of the number input box 830 is selected, the enhanced notification mode is set in the θ-axis direction (rotation direction) of the joint J4. When the radio button is deselected, the enhanced notification mode is not set in the θ-axis direction (rotation direction) of the joint J4. A number input box 831 allows to input the interval at which the repulsion potential field or attraction potential field is enhanced at virtual coordinates in the θ-axis direction (rotation direction) in which the reference coordinate set at the joint J5 moves. When the radio button on the sheet left side of the number input box 831 is selected, the enhanced notification mode is set in the θ-axis direction (rotation direction) of the joint J5. When the radio button is deselected, the enhanced notification mode is not set in the θ-axis direction (rotation direction) of the joint J5. A number input box 832 allows to input the interval at which the repulsion potential field or attraction potential field is enhanced at virtual coordinates in the θ-axis direction (rotation direction) in which the reference coordinate set at the joint J6 moves. When the radio button on the sheet left side of the number input box 832 is selected, the enhanced notification mode is set in the θ-axis direction (rotation direction) of the joint J6. When the radio button is deselected, the enhanced notification mode is not set in the θ-axis direction (rotation direction) of the joint J6.

A numeric value may be input to the number input boxes 824 to 832 by directly inputting a displayed value with a keyboard and a mouse or setting a value with the up-down arrow buttons of each of the number input boxes 824 to 832 using the mouse or touch.

An X-direction enhancement button 837 (radio button) is a button of a mode in which the virtual repulsion potential fields or virtual attraction potential fields in the X-axis direction in which the reference coordinate of the hand part of the robot arm body 200 moves are increased as described in the third embodiment. A Y-direction enhancement button 838 (radio button) is a mode in which the virtual repulsion potential fields or virtual attraction potential fields in the Y-axis direction in which the reference coordinate of the hand part of the robot arm body 200 moves are increased as described in the third embodiment. A Z-direction enhancement button 839 (radio button) is a mode in which the virtual repulsion potential fields or virtual attraction potential fields in the Z-axis direction in which the reference coordinate of the hand part of the robot arm body 200 moves are increased as described in the third embodiment. In the present embodiment, when the X-direction enhancement button 837, the Y-direction enhancement button 838, or the Z-direction enhancement button 839 is selected, the value input to the virtual repulsion setting input box 816 or the virtual attraction setting input box 817 is automatically set to 200% of the input value. However, an input box may be prepared one by one as needed to allow input of a value to be increased or a multiplication factor from the value input to the virtual repulsion setting input box 816 or the virtual attraction setting input box 817 may be configured to be set.

A light cycle setting input box 833 allows to set the cycle for blinking the light 260 in correspondence with the virtual coordinates passed, as described in the sixth embodiment. A sound cycle setting input box 834 allows to set the cycle for producing sound from the speaker 270 in correspondence with the virtual coordinates passed, as described in the seventh embodiment. A numeric value may be input to the light cycle setting input box 833 and the sound cycle setting input box 834 by directly inputting a value displayed with a keyboard and a mouse. A numeric value may be input by setting a value with the up-down arrow buttons of each of the number input boxes 824 to 832 using the mouse or touch. In the present embodiment, a numeric value is input to the light cycle setting input box 833 and the sound cycle setting input box 834 in seconds(s). Alternatively, a numeric value may be input in milliseconds (ms) or minutes.

A sound setting box 835 allows to select the type of sound, as described in the seventh embodiment. By using the up and down arrow buttons of the sound setting box 835, various sounds set in advance, such as buzzer, chime, and alarm, can be selected. A reset time setting input box 836 allows to set the duration of a non-operated state of the user when the count of virtual coordinates passed is reset, as described in the sixth to eighth embodiments. A numeric value may be input to the reset time setting input box 836 by directly inputting a value displayed with a keyboard and a mouse. A numeric value may be input by setting a value with the up-down arrow button of the reset time setting input box 836 using the mouse or touch. In the present embodiment, a numeric value may be input to the reset time setting input box 836 in seconds(s). Alternatively, a numeric value may be input in milliseconds (ms) or minutes.

According to the present embodiment, it is possible to easily perform settings for notifying the user of the amount of movement of the robot. Thus, for example, it is possible to make the user intuitively grasp the position of the robot according to user's feeling while the user is performing direct teaching, with the result that it is possible to improve the operability of robot operation by the user. The above-described various embodiments and modifications may be implemented in combination with the present embodiment and/or the present modification.

### Other Embodiments

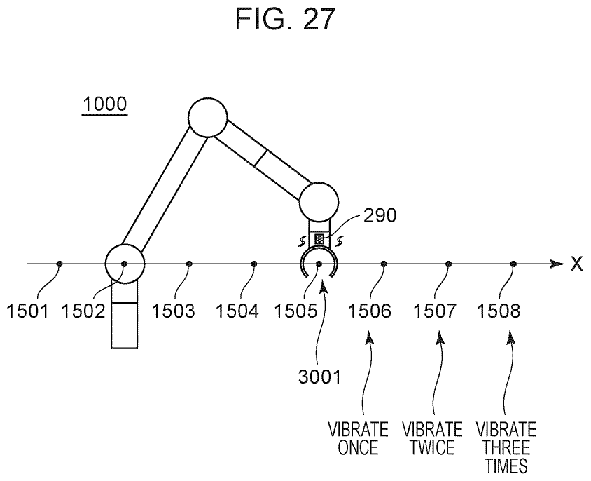

In the above-described sixth to eighth embodiments, notifications corresponding to virtual coordinates are made using light, sound, numerical display, and the like. However, it is also applicable to notify the user through vibration, other than light, sound, or numerical display. For example, a vibrator 290 is provided on the link 205 of the robot arm body 200 as shown in FIG. 27. Then, notification may be made by vibrating the vibrator 290 when the reference coordinate 3001 is positioned at or passes through a virtual coordinate.

When the movement is being performed consecutively in the same direction on the same axis, the vibrator 290 may be consecutively vibrated in correspondence with the number of virtual coordinates passed. For example, consider the case of moving the reference coordinate 3001 from the virtual coordinate 1505 to the virtual coordinate 1508, as shown in FIG. 27. These coordinates can be referred to as first positions or second positions. In that case, from FIG. 27, when the reference coordinate is positioned at the virtual coordinate 1506, the vibrator 290 is vibrated once in a second (vibrated at a frequency of once per second). When the reference coordinate 3001 is positioned at the virtual coordinate 1507 further from that state, the vibrator 290 is vibrated twice in a second (vibrated at a frequency of twice per second) because the reference coordinate 3001 is consecutively moving in the same direction on the same axis. When the reference coordinate 3001 is positioned at the virtual coordinate 1508 further from that state, the vibrator 290 is vibrated three times in a second (vibrated at a frequency of three times per second) because the reference coordinate 3001 is consecutively moving in the same direction on the same axis. In the present embodiment, the cycle is set to one second; however, a selected cycle may be set. Then, when the movement has not been detected for a predetermined time, the number of times of blinking is reset. The control flowchart is similar to those of the sixth to eighth embodiments.

The above-described various embodiments and modifications may be implemented in combination with the present embodiment (notification by vibration) and/or the present modification (notification by vibration). In the direct teaching settings screen 800 of the ninth embodiment, a vibration notification mode button and a vibration cycle setting input box may be displayed.

According to the above-described present embodiment (notification by vibration), the position of the robot is notified to the user by generating vibration when the user directly operates the robot. Thus, the user is able to operate the robot while grasping the coordinate during operation (while grasping how much the robot arm body 200 or the robot hand body 300 has moved). Thus, for example, it is possible to make the user intuitively grasp the position of the robot while the user is performing direct teaching, with the result that it is possible to improve the operability of robot operation by the user. The above-described various embodiments and modifications may be implemented in combination with the present embodiment and/or the present modification. For example, by combining the present embodiment with the first to fifth embodiments in which notification is provided through a change in operating force as described above, a clicking sensation is generated at the notification position, and vibration is also generated. Thus, it is possible to further clearly notify the user of the clicking sensation and the notification position, so it is also possible to improve an operating feel on the robot.

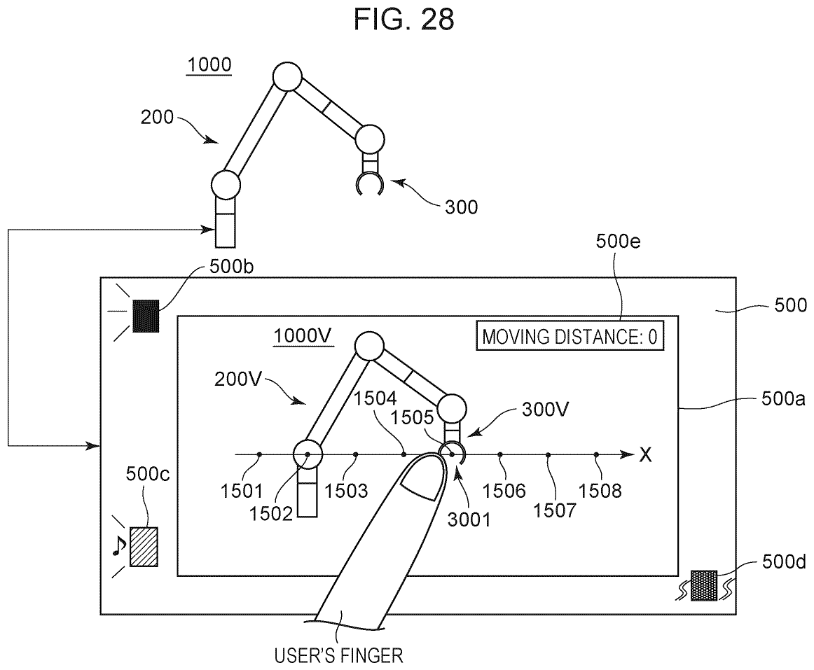

In the above-described various embodiments, an example of the case where the robot is operated through direct teaching has been described. Alternatively, for example, it is also applicable to the case where the robot is operated with an external input device (operating device), such as a teaching pendant. FIG. 28 is a diagram illustrating the case where the above-described various embodiments are implemented by using the tablet-form external input device 500. In FIG. 28, the description will be made by using a tablet form; however, a teaching pendant for operating the robot with a physical user interface, such as a smartphone, a general button, and a joystick, may be used.

As shown in FIG. 28, the tablet-form external input device 500 includes a touch panel display portion 500a. The display portion 500a displays a virtual robot system 1000V that represents the robot system 1000 in a virtual model, and also displays a virtual robot arm body 200V corresponding to the robot arm body 200, and a virtual robot hand body 300V. By operating the virtual robot arm body 200V and/or the virtual robot hand body 300V while touching them with the user's finger, it is possible to operate the robot arm body 200 and/or the robot hand body 300 of the real machine. For the sake of illustrative purposes, FIG. 28 shows an enlarged view of the external input device 500 and the user's finger.

The external input device 500 includes a light 500b capable of emitting light, a speaker 500c capable of producing sound, and a vibrator 500d capable of vibrating the external input device 500. The display portion 500a shows the virtual coordinates 1501 to 1508 and the virtual reference coordinate 3001, and also shows a numerical display section 500e displaying the moving distance of the reference coordinate 3001 in numeric value. Virtual force fields as described in the first to fourth embodiments are set at the virtual coordinates 1501 to 1508. Of course, as in the case of the fifth embodiment, the display portion 500a may show a virtual joint model and show force fields set within the rotation range at a virtual joint. In FIG. 28, the external input device 500 shows the X-axis and allows operation on the X-axis. Alternatively, the external input device 500 may show a plurality of axes (Y-axis and Z-axis) and may allow operation on the plurality of axes (Y-axis and Z-axis).

Then, from the state of FIG. 28, when the virtual robot hand body 300V is moved to the virtual coordinate 1506 by the user's finger, the operating force at the time of moving the virtual robot hand body 300V in a virtual space is controlled as in the case of the first to fourth embodiments. Thus, the user is able to perceive a virtual clicking sensation in the robot hand body 300.

When the virtual robot hand body 300V is moved, light from the light 500b may be blinked as in the case of the sixth embodiment, and light may be blinked multiple times according to the amount of movement of the reference coordinate 3001. When the virtual robot hand body 300V is moved, sound may be produced from the speaker 500c as in the case of the seventh embodiment. It is possible to produce sound multiple times and produce a corresponding sound (produce the sound “one” and produce the sound “two”) according to the amount of movement of the reference coordinate 3001. By performing a virtual clicking sensation through a virtual force field and a clicking sound from the speaker 500c in combination, it is possible for the user to further perceive a clicking sensation, so it is possible to improve an operating feel.

When the virtual robot hand body 300V is moved, display of the numeric value at the numerical display section 500e may be updated as in the case of the eighth embodiment, and numerical display may be performed according to the amount of movement of the reference coordinate 3001. When the virtual robot hand body 300V is moved, vibration may be generated from the vibrator 500d, and vibration may be generated multiple times according to the amount of movement of the reference coordinate 3001. By performing a virtual clicking sensation through a virtual force field and vibration of the vibrator 500d in combination, it is possible for the user to further perceive a clicking sensation, so it is possible to improve an operating feel. Furthermore, a virtual clicking sensation due to a virtual force field, vibration of the vibrator 500d, and sound produced from the speaker 500c all may be performed in combination. A virtual clicking sensation due to a virtual force field, blinking of light from the light 500b, sound produced from the speaker 500c, vibration of the vibrator 500d, numerical display by the numerical display section 500e all may be performed in combination.

According to the present embodiment (notification from the external input device), when a user operates the robot with the external input device 500, various notifications are provided by the external input device 500 to notify the user of the position of the robot. Thus, the user is able to operate the robot while grasping the coordinate during operation with the external input device 500 (while grasping how much the robot arm body 200 or the robot hand body 300 has moved). Thus, for example, it is possible to make the user intuitively grasp the position of the robot when the user is operating the robot with the external input device 500, with the result that it is possible to improve the operability of robot operation by the user.

By displaying virtual coordinates on the display portion 500a, it is possible to make the user intuitively grasp how much the robot can move. Of course, in cases where notification, such as operating force, light, and sound, is provided, the virtual coordinates may be hidden, and a user interface that allows the user to select whether to display or hide the virtual coordinates may be provided on the display portion 500a or the external input device 500. The above-described various embodiments and modifications may be implemented in combination with the present embodiment and/or the present modification. For example, a user interface for setting the details of notification as described in the ninth embodiment may be shown on the display portion 500a.

Procedures of the above-described embodiments are specifically executed by a CPU. Therefore, the CPU may be configured to read a recording medium, on which a program of software capable of executing the above-described functions is recorded, and run the program. In this case, the program itself read from the recording medium implements the functions of the above-described embodiments, and the program itself and the recording medium on which the program is recorded are components of the present disclosure.

In each of the embodiments, a case where a computer-readable recording medium is an ROM or an RAM or a flash ROM and a program is stored in the ROM or the RAM or the flash ROM has been described. However, the present disclosure is not limited to such modes. The program for carrying out the present disclosure may be recorded on any recording medium as long as the recording medium is a computer-readable recording medium.

In the above-described various embodiments, a case where an articulated robot arm in which the robot arm body 200 includes a plurality of joints is used has been described; however, the number of joints is not limited thereto. A vertical multi-axis configuration is described as a form of the robot arm. A configuration equivalent to the above can be implemented even with joints in a different form, such as a horizontal articulated type, a parallel link type, and an orthogonal robot.

The above-described various embodiments are applicable to machines capable of automatically performing extension and contraction, bending and stretching, up and down movements, right and left movements, or swing operation, or a combined operation of them in accordance with information of a storage device provided in a controller.

The present disclosure is not limited to the above-described embodiments and many modifications are applicable within the technical concept of the present disclosure. Advantageous effects described in the embodiments of the present disclosure are only the most favorable advantageous effects obtained from the present disclosure, and advantageous effects of the present disclosure are not limited to those described in the embodiments of the present disclosure. The above-described various embodiments and modifications may be implemented in combination.

According to the present disclosure, it is possible to improve the operability of robot operation by a user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

1. A robot system comprising:
a robot; and
a controller that controls the robot, wherein the controller
when a user is moving a predetermined part of the robot or moving the predetermined part with a terminal device, notifies the user that the predetermined part is moving from a first position to a second position.

2. The robot system according to claim 1, wherein
virtual repulsion or virtual attraction is set at the first position and the second position, and
the controller
notifies the user by, based on the repulsion or the attraction, changing operating force used when the user moves the predetermined part.

3. The robot system according to claim 2, wherein
the attraction is set at the first position and the second position, and
the controller
when the predetermined part is moving from the first position to the second position, changes the operating force based on a fact that a force set for the predetermined part changes from a force pulling to the first position to a force pulling to the second position.

4. The robot system according to claim 2, wherein
the controller
generates a clicking sensation due to a change in the operating force when the user is moving the predetermined part.

5. The robot system according to claim 2, wherein
the controller
increases the repulsion or the attraction at every predetermined number.

6. The robot system according to claim 2, wherein
the controller
when the predetermined part has moved at least twice consecutively in a predetermined direction, reduces the repulsion or the attraction, set in the predetermined direction.

7. The robot system according to claim 2, wherein
the controller
displays, on a display portion, a screen for setting the repulsion or the attraction.

8. The robot system according to claim 5, wherein
the controller
displays a screen for setting the predetermined number.

9. The robot system according to claim 5, wherein
the controller
displays, on a display portion, a screen for setting how to increase the repulsion or the attraction at every predetermined number.

10. The robot system according to claim 6, wherein
the controller
when the predetermined part has moved at least twice consecutively in a predetermined direction, displays, on a display portion, a screen for setting execution of control to reduce the repulsion or the attraction, set in the predetermined direction.

11. The robot system according to claim 1, wherein
the controller
notifies the user by light that the predetermined part is moving from the first position to the second position.

12. The robot system according to claim 11, wherein
the controller
when the predetermined part has moved at least twice consecutively in a predetermined direction, blinks the light according to the number of positions of the consecutive movements.

13. The robot system according to claim 11, wherein
the controller
displays, on a display portion, a screen for setting information related to the notification of light.

14. The robot system according to claim 1, wherein
the controller
notifies the user by sound that the predetermined part is moving from the first position to the second position.

15. The robot system according to claim 14, wherein
the controller
when the predetermined part has moved at least twice consecutively in a predetermined direction, generates the sound according to the number of positions of the consecutive movements or repeatedly generates the sound according to the number of the consecutive movements.

16. The robot system according to claim 14, wherein
the controller
displays, on a display portion, a screen for setting information related to the notification of sound.

17. The robot system according to claim 1, wherein
the controller
notifies the user by numerical display that the predetermined part is moving from the first position to the second position.

18. The robot system according to claim 17, wherein
the controller
when the predetermined part has moved at least twice consecutively in a predetermined direction, displays a numeric value according to the number of positions of the consecutive movements.

19. The robot system according to claim 1, wherein
the controller
notifies the user by vibration that the predetermined part is moving from the first position to the second position.

20. The robot system according to claim 19, wherein
the controller
when the predetermined part has moved at least twice consecutively in a predetermined direction, changes the number of the vibrations generated according to the number of positions of the consecutive movements.

21. The robot system according to claim 19, wherein
the controller
displays, on a display portion, a screen for setting information related to the notification of vibration.

22. The robot system according to claim 1, wherein
the controller
displays, on a display portion, a screen for setting an interval between the first position and the second position.

23. The robot system according to claim 1, wherein
displays, on a display portion, a screen for setting a mode to notify the user.

24. The robot system according to claim 1, wherein
the predetermined part is a part that moves in a three-dimensional space where the robot is placed, and
the first position and the second position are coordinates virtually set on at least one axis of the space.

25. The robot system according to claim 24, wherein
the controller notifies the user when the predetermined part has moved between the coordinates.

26. The robot system according to claim 1, wherein
the predetermined part is a part that moves by a joint of the robot, and
the first position and the second position are coordinates virtually set in a moving range of the joint.

27. The robot system according to claim 26, wherein
the controller
notifies the user that the joint has rotated by a half rotation.

28. The robot system according to claim 26, wherein
the joint is capable of rotating by 360 degrees or more, and
the controller notifies the user that the joint has rotated by 360 degrees or more.

29. The robot system according to claim 1, wherein
the controller
limits directions in which the user moves the predetermined part.

30. The robot system according to claim 1, further comprising
an operating device enabling the robot to be operated by input from the user, wherein
the controller
notifies the user by the operating device that the predetermined part is moving from the first position to the second position.

31. The robot system according to claim 30, wherein
a virtual robot that allows the user to be operated is displayed on a display portion of the operating device.

32. A manufacturing method for an article, comprising manufacturing an article by using the robot system according to claim 1.

33. A control method for a robot system including a robot and a controller that controls the robot, the control method comprising
by the controller,
when a user is moving a predetermined part of the robot or moving the predetermined part with a terminal device, notifying the user that the predetermined part is moving from a first position to a second position.

34. An information processing apparatus that sets information related to a robot system including a robot and a controller that controls the robot, wherein the information processing apparatus
displays, on a display portion, a screen for setting a condition that the controller, when a user is moving a predetermined part of the robot or moving the predetermined part with a terminal device, notifies the user that the predetermined part is moving from a first position to a second position.

35. An information processing method of setting information related to a robot system including a robot and a controller that controls the robot, the information processing method comprising
displaying, on a display portion, a screen for setting a condition that the controller, when a user is moving a predetermined part of the robot or moving the predetermined part with a terminal device, notifies the user that the predetermined part is moving from a first position to a second position.

36. (canceled)

37. A non-transitory computer-readable recording medium storing instructions that, when executed, configure an information processing apparatus to perform a method according to claim 35.
